(19) United States
(12) Patent Application Publication
(10) Pub. No.: US 2009/0029897 A1
(43) Pub. Date: Jan. 29, 2009

(54) Detergent or Cleaning Agent

(76) Inventors: Sandra Behr, Hilden (DE); Dirk Gerst, Duesseldorf (DE); Wolfgang Barthel, Langenfeld (DE); Salvatore Fileccia, Oberhausen (DE); Ulf Arno Timmann, Koeln (DE)

Correspondence Address: CONNOLLY BOVE LODGE & HUTZ LLP, PO BOX 2207, WILMINGTON, DE, 19899-2207, US

(21) Appl. No.: 11/991,896

(22) PCT Filed: May 6, 2006
(86) PCT No.: PCT/EP2006/004254

§ 371 Date: Jul. 23, 2008

(30) Foreign Application Priority Data
Jun. 3, 2005 (DE) 10 2005 025 964.2

(51) Int. Cl. C11D 17/04

(52) U.S. Cl. 510/296

(57) ABSTRACT

The invention relates to methods for producing a detergent or cleaning agent dosing unit, comprising the following steps: a) providing a detergent or cleaning agent shaped body in the form of an annular tablet having a cavity with at least two opening faces; b) sealing one opening face of the cavity with a prefabricated, filled and closed water-soluble container by linking the prefabricated sachet with the detergent or cleaning agent shaped body; c) filling the cavity with a composition that has a detergent or cleaning action. The inventive methods allow to jointly produce solid and liquid or flowable detergent or cleaning agent compositions in separate areas of a compact dosing unit.

The present invention belongs to the field of washing or detergent compositions. In particular, the present invention relates to a method for the production of washing or detergent compositions, especially of unit doses for washing or detergent compositions.

Washing or detergent compositions are available to consumers in a wide variety of forms nowadays. In addition to detergents in the form of powder or granules, the available choices also include, for example, detergent concentrates in the form of extruded or tabletted compositions. These solid, concentrated or compacted products are characterized by a lower volume per unit dose, thus reducing the costs for packaging and transportation. In this context, especially washing or detergent composition tablets meet consumers' desire for simpler dispensing. Such compositions are comprehensively described in the state of the art. Aside from the cited advantages, however, compacted washing or detergent compositions also entail a number of drawbacks. Particularly tabletted forms, owing to their high degree of compaction, often display a delayed disintegration and thus a delayed release of their ingredients. In order to resolve this “contradiction” between sufficient tablet hardness and short disintegration times, the patent literature discloses numerous technical solutions, reference being made here to the use of so-called tablet disintegrants by way of an example. These disintegration accelerators are added to the tablets in addition to the washing-active or detergent-active substances whereby, as a rule, they themselves do not have any washing-active or detergent-active properties and, as a result, they increase the complexity and the costs of these compositions. Another disadvantage of the tabletting of active-substance mixtures, especially of washing-active or detergent-active mixtures, is the inactivation of the contained active substances caused by the compacting pressure that occurs during the tabletting. The active substances can also become inactivated by a chemical reaction owing to the enlarged contact surface areas of the ingredients.

As an alternative to the above-mentioned particulate or compacted washing or detergent compositions, in recent years, solid or liquid washing or detergent compositions in a water-soluble or water-dispersible pouch have been increasingly described. Like the tablets, these compositions are characterized by simplified dispensing since they can be dispensed into the washing machine or dishwasher right in the pouch and, moreover, they also simultaneously allow the fabrication of washing or detergent compositions in liquid or powder form that, in comparison to the compacted products, have better dissolving properties and faster action.

Thus, for instance, European patent application EP 1 314 654 A2 (Unilever) discloses a dome-shaped pouch having a compartment that contains a liquid.

The subject matter of international patent application WO 01/83657 A2 (Procter & Gamble), in contrast, is a pouch that contains two granular solids in a compartment, each solid being present in fixed regions so that they cannot mix with each other.

In addition to pouches that have only one compartment, the state of the art also discloses forms that have more than one compartment or more than one type of formulation.

The subject matter of European patent application EP 1 256 623 A1 (Procter & Gamble) is a kit consisting of at least two pouches having different compositions and a different appearance. The pouches are present separately from each other and not as a compact single product.

A method for the production of multi-compartment pouches by gluing together two individual compartments is described in international patent application WO 02/857361 A1 (Reckitt Benckiser).

The objective of the present invention was to provide a method for the production of washing or detergent compositions that allows the joint fabrication of solid and liquid or flowable compositions of washing or detergent compositions in separate areas of a compact unit dose. The end product of the method should have an attractive appearance.

This objective is achieved by means of a method for the production of washing or detergent composition shaped articles with which a washing-active or detergent-active ring tablet is sealed by means of a pre-fabricated, filled and closed water-soluble pouch.

Consequently, the subject matter of the present application is a method for the production of a washing or detergent composition unit dose comprising the following steps:
a) provision of a washing or detergent composition shaped article in the form of a ring tablet having a cavity with at least two opening surfaces;
b) closing of one opening surface of the cavity with a pre-fabricated, filled and closed water-soluble packet;
c) filling of the cavity with a washing-active or detergent-active composition.

Compacted, preferably tabletted, extruded or cast, shaped articles are employed in the compositions according to the invention as the detergent shaped articles in the form of a ring tablet. However, tabletted shaped articles are particularly preferred within the scope of the present application. Consequently, a preferred subject matter is a method for the production of a washing or detergent composition unit dose, comprising the following steps:
a) provision of a washing or detergent composition shaped article in the form of a ring tablet having a cavity with at least two opening surfaces;
b) closing of one opening surface of the cavity with a pre-fabricated, filled and closed water-soluble packet;
c) filling of the cavity with a washing-active or detergent-active composition.

The production of washing or detergent composition tablets is preferably carried out in the manner known to the person skilled in the art by compressing particulate starting substances. In order to produce the tablets, the pre-mix is compacted in a so-called impression die between two punches to form a solid compressed piece. This procedure, which will be referred to below as tabletting, is broken down into four segments: metering, compacting (elastic deformation), plastic deformation and ejection The tabletting is preferably carried out on so-called rotary pelleting machines.

When it comes to tabletting using rotary pelleting presses, it has been found to be advantageous to carry out the tabletting with the smallest possible fluctuations in the weight of the tablets. This also reduces the fluctuations in the hardness of the tablets. The weight fluctuations can be kept to a minimum in the following manner:
12 use of plastic inserts having small thickness tolerances
13 low rotational speed of the rotor
14 large filling shoes
15 coordinating the rotational speed of the filling shoe vanes with the rotational speed of the rotor
16 filling shoe with a constant powder height
17 uncoupling of the filling shoe and the powder reservoir

All non-stick coatings known from the state of the art lend themselves for purposes of reducing caking on the punches. Particularly advantageous are plastic coatings, plastic inserts or plastic punches. Rotary punches have also proven to be advantageous, whereby the upper and lower punches should be configured to be rotatable if at all possible. In the case of rotary punches, it is usually possible to dispense with a plastic insert. Here, the punch surfaces should be electropolished.

The methods preferred within the scope of the present invention are characterized in that the compression takes place at compacting pressures ranging from 0.01 to 50 kNcm⁻², preferably from 0.1 to 40 kNcm⁻² and especially from 1 to 25 kNcm⁻².

The tablets can have one or more phases. The individual phases of two-phase or multi-phase tablets are preferably arranged in layers. The weight ratio of the phase with the lowest weight percentage in the tablet is preferably at least 50% by weight, preferably at least 10% by weight and especially at least 20% by weight. In the case of two-phase tablets, the weight percentage of the phase with the highest weight percentage in the tablet is preferably not more than 90% by weight, especially not more than 80% by weight and particularly between 55% and 70% by weight. In the case of three-phase tablets, the weight percentage of the phase with the highest weight percentage in the tablet is preferably not more than 80% by weight, especially not more than 70% by weight and particularly between 40% and 60% by weight.

In another preferred embodiment of the washing or detergent composition shaped articles according to the invention, the tablet is structured like an onion. With such a tablet, at least one inner layer is completely surrounded by at least one outer layer.

The term “cavity” as used within the scope of the present invention designates openings or holes that pass through the shaped article and that connect two sides of the shaped article to each other, preferably two opposite sides of the shaped article, for instance, the bottom and the top surface of the shaped article.

The shape of the cavity can be selected as desired, whereby tablets are preferred in which at least one cavity has at least one symmetrical opening surface, whereby special preference is given to circular or oval, triangular, rectangular, pentagonal, hexagonal or octagonal opening surfaces. Symmetrical opening surfaces make it easier to seal this opening surface with the pre-fabricated water-soluble packet in step b) since the alignment of the packet in the opening surface is simplified as a function of the degree of symmetry. Of course, completely irregular trough shapes, for example, in the shape of arrows, animals, trees, clouds, etc. can also be created.

In an especially preferred embodiment, the cavity is a through-hole that connects two opposite sides of the shaped article to each other. Such a shaped article can be referred to as a simple ring element. The opening surfaces of the through-hole in the surface of this ring element can be the same size or else they can differ in terms of their size. If a tablet is employed as the shaped article, then the shaped article with such a through-hole corresponds to a so-called simple ring tablet. Particularly preferred are those shaped articles with a through-hole where the opening surfaces of the through-hole on the opposite sides of the shaped article differ by less than 80%, preferably by less than 60%, especially by less than 40%, particularly preferred by less than 20% and in particular by less than 10%, relative to the larger of the two opening surfaces. Special preference is given to the use of ring tablets whose opening surfaces of the through-hole are the same size. The cross section of the through-hole can be angular or round. Cross sections having one, two, three, four, five, six or more corners can be realized but, within the scope of the present Invention, special preference is given to shaped articles that have a through-hole without corners, preferably a through-hole having a round or oval cross section. The term “cross section” here refers to a surface area that is perpendicular to a straight connecting line between the center points of the two opposite opening surfaces of the shaped article.

Of course, the shaped article can have more than one cavity. Shaped articles having two, three, four, five, six, seven, eight, nine, ten, eleven, twelve or more cavities are especially preferred within the scope of the present application.

The volume of the cavity preferably amounts to between 0.1 ml and 20 ml, especially between 0.2 ml and 15 ml, particularly preferred between 1 ml and 10 ml and, in particular, between 2 ml and 7 ml.

According to the invention, preference is given to washing or detergent composition shaped articles that are characterized in that the cavity has two openings located on opposite sides of the shaped article.

In step b) of the method according to the invention, one of the opening surfaces of the cavity of the washing or detergent composition shaped article is closed with a pre-fabricated, filled and closed water-soluble packet. In this context, the opening surface is closed in such a way that, in the subsequent step c), the cavity can be filled with a washing composition or detergent composition without the risk that some or all of the composition can escape from the opening surface that is closed with the packet.

Aside from the generally known tubular bags, thermoformed or injection-molded packets are particularly well-suited as the pre-fabricated, filled water-soluble packets owing to their greater flexibility when it comes to shaping.

The thermoforming is preferably done by placing a film material over the cavity and then molding the film material into this cavity under the effect of pressure and/or vacuum. Here, before or during the molding, the film material can be pretreated by exposing it to heat and/or solvents and/or by conditioning it by means of relative humidity values and/or temperatures that differ from the ambient conditions. The pressure effect can be brought about using a tool. However, the effect of compressed air and/or the film's own weight and/or the weight of an active substance placed onto the top of the film are also suitable to generate pressure forces.

After the thermoforming process, preferably using vacuum, the thermoformed film material is affixed inside the cavity in the spatial shape it has acquired due to the thermoforming procedure. In this context, the vacuum is preferably applied continuously, all the way from the thermoforming until the filling and preferably until the sealing procedure and especially until the compartments are segregated. Discontinuous vacuum can also be successfully employed, for example, in order to thermoform the compartments and (after an interruption) before and during the filling of the compartments. The strength of the continuous or discontinuous vacuum can also be varied so that, for example, higher values are employed at the beginning of the process (when the film is being thermoformed) than at its end (during the filling or sealing or segregating procedures).

As already mentioned, the film material can be pretreated by exposure to heat before or during its molding into the cavity of the shaped articles. In this process, the film material—preferably a water-soluble or water-dispersible polymer film—is heated for up to 5 seconds, preferably for 0.1 to 4 seconds, especially preferred for 0.2 to 3 seconds and particularly for 0.4 to 2 seconds, to temperatures above 60° C. [140° F.], preferably above 80° C. [176° F.], especially preferred between 100° C. and 120° C. [212° F. and 248° F.] and particularly to temperatures between 105° C. and 115° C. [221° F. and 239° F.]. In order to dissipate this heat, especially also to dissipate the heat (e.g. melting) brought in by the compositions that are filled into the thermoformed compartments, the films are preferably cooled after the thermoforming. Here, the cooling preferably takes place at temperatures below 20° C. [68° F.], preferably below 15° C. [59° F.], especially preferred at temperatures between 2° C. and 14° C. [35.6° F. and 57.2° F.], and particularly at temperatures between 4° C. and 12° C. [39.2° F. and 53.6° F.]. Preferably, the cooling is carried out continuously, from the beginning of the thermoforming procedure all the way to the sealing and segregation of the compartments.

This cooling procedure, like the above-mentioned continuous or discontinuous application of a vacuum, has the advantage of preventing the thermoformed packets from shrinking back after the thermoforming, as a result of which not only the appearance of the product of the method is improved but, at the same time, the compositions filled into the compartments are prevented from escaping over the edge of the compartments for example, into the sealing areas of the compartments. Therefore, this avoids problems when the filled compartments are sealed.

The thermoformed packets can have one, two, three or more compartments. These compartments can be arranged in the thermoformed packet next to each other and/or one above the other. Preferably, the individual compartments of the thermoformed packet are filled with different compositions. It is especially preferred for at least one compartment of a thermoformed packet to be filled with a liquid while at least one other compartment of this thermoformed packet is filled with a solid.

When it comes to the film material for the thermoformed packets, preference is given to the use of cellulose ether, pectins, polyethylene glycols, polyvinyl alcohols, polyvinyl pyrrolidones, alginates, gelatins or starches.

The water-soluble or water-dispersible packets can also be manufactured by means of injection molding. In this context, injection molding refers to the shaping of a molding compound in such a way that the compound held in a compound cylinder for more than one injection-molding procedure is plastically softened upon exposure to heat, after which it flows under pressure through a nozzle into the cavity of a previously closed mold. This method is employed primarily for non-curable molding compounds that solidify in the mold as they cool off. Injection molding is a very cost-efficient, modern method for the production of objects created through non-cuffing shaping and it especially lends itself for automated mass production. In actual practice, the thermoplastic molding compounds (powder, granules, pellets, pastes, etc.) are heated up until they become liquefied (up to 180° C. [356° F.]), after which they are injected at a high pressure (up to 140 MPa) into closed, two-part, preferably water-cooled hollow molds, that is to say, molds consisting of a cavity plate (female mold) and a core plate (male mold), where the molding compounds then coot off and solidify. Plunger-type as well as screw-type injection-molding machines can be employed. Water-soluble polymers such as, for instance, cellulose ether, pectins, polyethylene glycols, polyvinyl alcohols, polyvinyl pyrrolidones, alginates, gelatins or starches are suitable as the molding compounds (injection-molding compounds).

For purposes or sealing the thermoformed packets or the injection-molded packets, the opening surface of the packet in question is preferably closed with a water-soluble film material, whereby the thermoformed or injection-molded packet and the water-soluble film material are preferably joined to each other by means of an adhesive, latching, snap-on or plug-in connection. Especially preferably, the water-soluble packet has an adhesive connection or a heat-sealed seam along which it is joined to the film material that closes the opening surface. The adhesive connection or the heat-sealed sears is preferably intrinsically Closed and preferably encircles the opening surface of the packet.

In step b) of the method according to the invention, the opening surface of the cavity is closed with the pre-fabricated packet in such a manner that the washing-active or detergent-active composition filled in step c) cannot escape through the closed opening surface. For example, the opening surface can be closed by simply placing the water-soluble packet onto the opening surface of the shaped article or, alternatively, by placing the shaped article onto the water-soluble packet. Step b) does not necessarily involve the formation of an adhesive connection between the shaped article and the water-soluble packet. Of course, such an adhesive connection can already be formed in step b), but this can also occur at a later point in time, for instance, during the filling in step c) or after the completion of the filling in step c). In any case, preference is given to those methods in which the washing or detergent composition unit dose and the pre-fabricated packet are joined by means of an adhesive connection, preferably by an adhesive, latching, snap-on or plug-in connection.

When it comes to the adhesive connection of the washing or detergent composition shaped article to the water-soluble packet, it is especially suitable to use adhesives or glues or else to heat-seal the shaped article and the packet. In a preferred embodiment, the heat-sealing is preferably done through exposure to heated sealing tools, or to a laser beam or to hot air. According to the invention, preference is given to methods that are characterized in that the washing or detergent composition shaped article and the pre-fabricated, filled and closed water-soluble packet are adhesively joined to each other through exposure to a heated sealing tool.

The adhesive connection between the shaped article and the water-soluble packet is preferably realized by means of a glued connection or a heat-sealed seam. This glued connection or heat-sealed seam can join the shaped article to the water-soluble packet in a punctiform manner; in such a case, the shaped article and the water-soluble packet are preferably joined to each other by means of two, three, four, five, six or more individual glued connections separated from each other or else by heat-sealed seams. Preference, however, is given to an embodiment in which the glued connection or the heat-sealed seam is realized in the form of an intrinsically sealed glued connection or heat-sealed seam that encircles the opening surface of the shaped article.

As described above, the water-soluble packet is preferably closed by means of a glued connection or a heat-sealed seam. When such a packet is now placed onto the opening surface of a shaped article in step b) and subsequently adhesively joined to the shaped article by another glued connection or another heat-sealed seam, then these glued connections and/or heat-sealed seams can be arranged next to each other, one above the other or overlapping each other. In a preferred embodiment of the method according to the invention, the adhesive connection between the shaped article and the water-soluble packet is achieved by means of a glued connection or a heat-sealed seam in such a way that the corresponding connections or seams do not intersect with each other.

In order to improve the adhesion between the washing or detergent composition shaped article and the water-soluble packet, the shaped article preferably has a coating. Water-soluble or water-dispersible polymers are particularly preferably employed as the coating materials. Special preference is given to methods in which the coating of the shaped article and the sheathing material of the water-soluble packet comprise at least a shared water-soluble or water-dispersible polymer. Especially preferred methods are those in which the coating of the shaped article as well as the sheathing material of the water-soluble packet comprise a polyvinyl alcohol.

Preference is given to methods that are characterized in that the pre-fabricated and filled water-soluble packet is a thermoformed packet or an injection-molded packet.

Therefore, another subject matter of the present application is a method for the production of a washing or detergent composition unit dose, comprising the following steps:
a) provision of a washing or detergent composition shaped article in the form of a ring tablet having a cavity with at least two opening surfaces;
b) closing of one opening surface of the cavity with a pre-fabricated, filled and closed thermoformed or injection-molded water-soluble packet;
c) filling of the cavity with a washing-active or detergent-active composition.

Preference is especially given to a method for the production of a washing or detergent composition unit dose, comprising the following steps:
a) provision of a washing or detergent composition shaped article in the form of a ring tablet having a cavity with at least two opening surfaces;
b) closing of one opening surface of the cavity with a pre-fabricated, filled and closed thermoformed or injection-molded water-soluble packet in that the washing or detergent composition shaped article is placed onto the water-soluble packet;
c) filling of the cavity with a washing-active or detergent-active composition.

Special preference is given to a method for the production of a washing or detergent composition unit doses comprising the following steps:
a) provision of a washing or detergent composition shaped article in the form of a ring tablet having a cavity with at least two opening surfaces;
b) closing of one opening surface of the cavity with a prefabricated, filled and closed thermoformed or injection-molded water-soluble packet in that the washing or detergent composition shaped article is placed onto the water-soluble packet in such a way that the packet projects into the opening surface and at least partially fills up the cavity of the shaped article;
c) filling of the cavity with a washing-active or detergent-active composition.

Methods that employ special thermoforming female molds have proven to be particularly advantageous. These thermoforming female molds have not only the actual thermoforming trough but also a depression that surrounds this trough and that is dimensioned in such a manner that it is capable of precisely accommodating the shaped article that has been placed onto the pre-fabricated, closed packet in process step b).

The depth of this depression is preferably less than 5 mm, preferably less than 4 mm and especially between 0.2 mm and 3 mm. The use of this depression allows the shaped article to be placed precisely above the pre-fabricated water-soluble packet, as a result of which a consistent quality can be ensured, especially of the glued connections and of the heat-sealed seams between the water-soluble packet and the shaped articles.

Therefore, preference is also given to a method for the production of a washing or detergent composition unit dose, comprising the following steps:
a) provision of a washing or detergent composition shaped article in the form of a ring tablet having a cavity with at least two opening surfaces;
b) closing of one opening surface of the cavity with a pre-fabricated, filled and closed thermoformed water-soluble packet that is located in the trough of a thermoforming female mold in that the washing or detergent composition shaped article is placed onto the water-soluble packet and, in this process, is fitted into a depression that surrounds the thermoforming trough;
c) filling of the cavity with a washing-active or detergent-active composition.

The pre-fabricated, filled and closed water-soluble packet is preferably filled with a flowable washing-active or detergent-active composition, preferably a liquid, especially a melt or a gel, a powder, a granulated product, an extruded product or a compacted product.

In the present application, the term “liquid” designates substances or substance mixtures as well as solutions or suspensions that are present in the liquid state of aggregation.

The liquids filled into the pre-fabricated water-soluble packets can range from having low to high viscosity. Especially preferred liquids are those having a viscosity (Brookfield viscometer LVT-II at 20 rpm and 20° C. [68° F.], spindle 3) ranging from 500 to 100,000 mPa·s, preferably from 1000 to 50,000 mPa·s, especially preferred from 1200 to 10,000 mPa·s and particularly from 1300 to 5000 mPa·s.

Powder is the general designation for a product obtained by breaking solid substances and/or substance mixtures, obtained by comminution, that is to say, trituration or crushing in a mortar (pulverization), by grinding in mills or as a result of spray drying or freeze drying.

A very fine comminution is often called atomization or micronization; such powders are called micro-powders.

Powder is usually roughly classified as coarse, fine and ultra-fine as a function of the particle size; a more precise classification of pulverulent bulk materials takes place via their bulk density and by means of screen analysis. Preferred powders within the scope of the prevent invention, however, have lower particle sizes below 5000 μm, preferably less than 3000 μm, particularly less than 1000 μm, especially preferred between 50 μm and 1000 μm and, in particular, between 100 μm and 800 μm.

Powders can be compacted and agglomerated by extrusion, compression, rolling, briquetting, pelleting and related methods. In principle, every method known from the state of the art for the agglomeration of particulate mixtures is suitable to produce the solids contained in the compositions according to the invention. Aside from granules, preference is given to the use of compacted products and extruded products within the scope of the present invention.

The term granules refers to clusters of granulate particles. A granulate particle (granule) is an asymmetrical aggregate made up of powder particles. Granulation methods are widely described in the state of the art. Granules can be produced by means of moist granulation, dry granulation or compacting as well as by melt-solidification granulation.

The most common granulation technique is moist granulation since this technique entails the fewest limitations and is the most reliable one to yield granules having favorable properties. Moist granulation is done by moistening the powder mixtures with solvents and/or solvent mixtures and/or solutions of binders and/or solutions of adhesives and is preferably carried out in mixers, agitated beds or spray towers, whereby said mixers can be equipped, for example, with agitator and kneading tools. However, combinations of agitated bed(s) and mixer(s) or combinations of several mixers can be employed for the granulation. The granulation is conducted under exposure to low to high shearing forces, depending on the starting material as well as on the desired product properties.

If the granulation is carried out in a spray tower, the starting substances that can be used are, for example, melts (melt solidification) or preferably aqueous slurries (spray drying) of solid substances which are sprayed from the tip of the tower with a defined droplet size, after which they solidify or dry in a free fall and accumulate as granules at the bottom of the tower. Melt solidification generally lends itself particularly for shaping low-melting substances that are stable within the range of the melting temperature (for instance, urea, ammonium nitrate and various formulations such as enzyme concentrates, pharmaceuticals, etc., Such granules are also referred to as prills. Spray drying is used especially for the production of detergents or detergent ingredients.

Other agglomeration techniques described in the state of the art are extruder or rotary piercing mill granulation techniques in which powder mixtures, optionally mixed with a granulating liquid, are plastically deformed by being pressed through perforated disks (extrusion) or on rotary piercing mills. The products of extruder granulation are also called extrudates.

In a preferred embodiment, the pre-fabricated water-soluble packet is filled with a two-phase or multiphase composition. Especially two-phase liquids, particularly two-phase gels, are preferred.

In another preferred embodiment, the pre-fabricated water-soluble packet is filled with a gel and a solid that is suspended in the gel, whereby special preference is given to solid particles having a particle size of more than 500 μm, preferably above 600 μm, preferred above 700 μm, especially preferred between 800 μm and 50,000 μm, and particularly between 1000 and 25,000 μm.

Preference is given to methods that are characterized in that the pre-fabricated, filled and closed water-soluble packet is filled with a flowable, washing-active or detergent-active composition, preferably with a liquid or gel-like washing-active or detergent-active composition. Water-soluble packets filled with liquid preferably have an air bubble in their interior. The degree of filling of these packets is preferably less than 95% by volume, more preferred between 80% and 95% by volume.

In step c) of the method according to the invention, the cavity of the washing or detergent composition shaped articles is filled with a washing-active or detergent-active composition. In a particularly preferred manner, flowable washing-active or detergent-active formulations, preferably liquids, especially melts or gels, powders, granules, extruded or compacted products are filled in during step c). Special preference is given to methods in which the washing-active or detergent-active compositions filled into the water-soluble packets differ from the washing-active or detergent active compositions filled into the cavity in terms of their physical properties (state of aggregation, density) or of their chemical properties (composition, ingredients).

Preference is given to methods that are characterized in that the cavity is filled with a flowable washing-active or detergent-active composition, preferably a solid washing-active or detergent-active composition, in step c).

After the filling procedure, the cavity of the washing or detergent composition shaped article is especially preferably sealed in an additional step d), whereby the sealing is preferably done by means of a water-soluble film or another pre-fabricated, filled and closed water-soluble packet by means of an adhesive connection of the water-soluble film or of the other prefabricated and filled water-soluble packet to the washing or detergent composition shaped article. The materials suitable for the water-soluble film(s) used in step d) or as a sheathing material for the pre-fabricated packet are especially the above-mentioned water-soluble or water-dispersible polymers from the group consisting of cellulose ethers, pectins, polyethylene glycols, polyvinyl alcohols, polyvinyl pyrrolidones, alginates, gelatins or starches.

Preference is given to methods that are characterized in that, in an additional step d), the other opening surface(s) of the cavity is/are sealed.

In a particularly preferred manner, the cavity is also sealed in step d) through the formation of an adhesive connection between the water-soluble film or the additional pre-fabricated, filled, closed water-soluble packet and the washing or detergent composition shaped article through exposure to a preferably heated sealing tool.

The unit doses manufactured on the basis of the method according to the invention contain washing-active or detergent-active substances as a component of the washing or detergent composition shaped article prepared in step a), as a component or as a filling of the prefabricated packet provided in step b) and as a component of the composition filled in during step c).

The preferred washing-active or detergent-active substances contained in the unit doses are substances from the group consisting of detergent builders, surfactants, polymers, bleaching agents, bleach activators, enzymes, glass corrosion inhibitors, corrosion inhibitors, disintegration auxiliaries, fragrances and perfume carriers. These as well as other preferred ingredients will be described in greater detail below.

The detergent builders include especially the zeolites, silicates, carbonates, organic co-builders and—if there are no environmental objections to their use—also the phosphates.

Preference is given to the use of crystalline layered silicates having the general formula NaMSiₓO₂ₓ₊₁.y H₂O, wherein M stands for sodium or hydrogen, x is a number from 1.9 to 22, preferably from 1.9 to 4, whereby 2, 3 or 4 are the especially preferred values for x, and y stands for a number from 0 to 33, preferably from 0 to 20. The crystalline layered silicates having the formula NaMSiₓO₂ₓ₊₁.y H₂O are sold, for instance, by Clariant GmbH (Germany) under the brand name Na-SKS. Examples of these silicates are Na-SKS-1 (Na₂Si₂₂O₄₅.x H₂O, kenyaite), Na-SKS-2 (Na₂Si₁₄O₂₉₇.x H₂O magadiite), Na-SKS-3 (Na₂Si₈O₁₇.x H₂O) or Na-SKS-4 (Na₂Si₄O₉.x H₂O, makatite).

Particularly well-suited for the purposes of the present invention are crystalline layered silicates having the formula NaMSiₓO₂ₓ₊₁.y H₂O, wherein x stands for 2. Special preference is given to β-sodium disilicates as well as δ-sodium disilicates Na₂Si₂O₅.y H₂O and also especially Na-SKS-5 (α-Na₂Si₂O₅, Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅) and Na-SKS-13 (NaHSi₂O₅) and especially Na-SKS-6 (δ-Na₂Si₂O₅).

The washing or detergent compositions preferably contain 0.1% to 20% by weight, especially 0.2% to 15% by weight, and particularly 0.4% to 10% by weight, of the crystalline layered silicate having the formula NaMSiₓO₂ₓ₊₁.y H₂O, in each case relative to the total weight of these compositions.

It Is also possible to use amorphous sodium silicates having an Na₂O:SiO₂ modulus ranging from 1:2 to 1:3.3, preferably from 1:2 to 1:2.8 and especially from 1:2 to 1:2.6, which preferably dissolve with a delay and have secondary washing properties. The delay in dissolving in comparison to conventional amorphous sodium silicates can be brought about in various ways, for instance, by means of surface treatment, compounding, compacting/compression or overdrying. Within the scope of this invention, the term “amorphous” means that, in X-ray diffraction experiments, the silicates do not display any of the sharp X-ray reflections of the type that are typical of crystalline substances, but rather, at the most, they bring about one or more maxima of the scattered X-ray radiation having a width of several degrees of the diffraction angle.

As an alternative or in combination with the above-mentioned amorphous sodium silicates, X-ray-amorphous silicates are employed whose silicate particles display blurred or even sharp diffraction maxima in electron-diffraction experiments. This can be interpreted to the effect that the products have microcrystalline areas measuring from ten to a few hundred nanometers in size, whereby values up to a maximum of 50 nm and especially up to a maximum of 20 nm are preferred. Such X-ray amorphous silicates likewise have a delay in dissolving in comparison to conventional water glasses, Particularly preferred are compacted/compressed amorphous silicates, compounded amorphous silicates and overdried X-ray amorphous silicates.

Within the scope of present invention, it is preferred if this/these silicate(s), preferably alkali silicates, especially preferred crystalline or amorphous alkali disilicates, is/are contained in washing or detergent compositions in amounts ranging from 3% to 60% by weight, preferably from 8% to 50% by weight and especially from 20% to 40% by weight, each time relative to the weight of the washing or detergent composition.

Of course, generally known phosphates can also be employed as builder substances, provided that their use is not to be avoided for environmental reasons. Among the large variety of commercially available phosphates, the most important ones are the alkali metal phosphates, and pentasodium triphosphate or pentapotassium triphosphate (sodium polyphosphate or potassium polyphosphate) are particularly preferred in the washing and detergent composition industry.

The term alkali metal phosphates refers to the general designation of alkali metal salts (especially sodium salt and potassium salt) of the various phosphoric acids, for which a distinction can be made between metaphosphoric acids (HPO₃)ₙ and orthophosphoric acid H₃PO₄ as well as higher-molecular representatives. The phosphates combine several advantages: they act as alkali carriers, prevent lime deposits on machine parts or lime incrustations in fabrics and also contribute to the cleaning performance.

Technically important phosphates are pentasodium triphosphate, Na₅P₃O₁₀ (sodium tripolyphosphate) as well as the corresponding potassium salt pentapotassium triphosphate, K₅P₃O₁₀ (potassium tripolyphosphate). According to the invention, preference is also given to the use of the sodium potassium tripolyphosphates.

If phosphates are employed within the scope of the present invention as washing-active or detergent-active substances in washing or detergent compositions, then preferred compositions contain this/these phosphate(s), preferably alkali metal phosphate(s), especially preferred pentasodium triphosphate or pentapotassium triphosphate (sodium tripolyphosphate or potassium tripolyphosphate), in amounts ranging from 5% to 80% by weight, preferably from 15% to 75% by weight and especially from 20% to 70% by weight, each time relative to the weight of the washing or detergent composition.

Other detergent builders are the alkali carriers. Alkali metal hydroxides, alkali metal carbonates, alkali metal hydrogen carbonates, alkali metal sesquicarbonates, the so-called alkali silicates, alkali metal silicates and mixtures of the above-mentioned substances are examples of alkali carriers, whereby the alkali carbonates, particularly sodium carbonate, sodium hydrogen carbonate or sodium sesquicarbonate are preferably employed within the scope of this invention. Particular preference is given to a builder system containing a mixture of tripolyphosphate and sodium carbonate. Likewise especially preferred is a builder system containing a mixture of tripolyphosphate and sodium carbonate and sodium disilicate. Owing to the fact that, in comparison to other builder substances, the alkali metal hydroxides have a low compatibility with the other ingredients of washing or detergent compositions, they are preferably employed only in small quantities, preferably in amounts of less than 10% by weight, preferably below 6% by weight, especially preferred below 4% by weight and particularly below 2% by weight, each time relative to the total weight of the washing or detergent composition. Special preference is given to compositions which, relative to the total weight, contain less than 0.5% by weight, and particularly no alkali metal hydroxides.

Especially preferred is the use of carbonate(s) and/or hydrogen carbonate(s), preferably alkali carbonate(s), particularly preferably sodium carbonate, in amounts ranging from 2% to 50% by weight, preferably 5% to 40% by weight and especially 7.5% to 30% by weight, each time relative to the weight of the washing or detergent composition. Special preference is given to compositions which, relative to the total weight, contain less than 17% by weight, preferably less than 13% by weight and particularly less than 9% by weight, of carbonate(s) and/or hydrogen carbonate(s), especially preferably sodium carbonate.

Examples of organic co-builders are, in particular, polycarboxylates/polycarboxylic acids, polymeric polycarboxylates, aspartic acid, polyacetals, dextrins, other organic co-builders as well as phosphonates. This class of substances will be described below.

Examples of useable organic builder substances are the polycarboxylic acids that can be employed in the form of their free acids and/or their sodium salts, whereby the term polycarboxylic acids refers to those carboxylic acids that have more than one acid function. These are, for instance, citric acid, adipic acid, succinic acid, glutaric acid, malic acid, tartaric acid, maleic acid, fumaric acid, sugar acids, aminocarboxylic acids, nitrilotriacetic acid (NTA), insofar as their use is not objectionable for environmental reasons, as well as mixtures thereof. The free acids have not only their builder effect but typically also the property of an acidification component and thus also serve to set a lower and milder pH value for the washing or detergent compositions. Particular mention should be made here of citric acid, succinic acid, glutaric acid, adipic acid, gluconic acid and any desired mixtures of these.

Likewise suitable detergent builders are polymeric polycarboxylates; these are, for instance, the alkali metal salts of polyacrylic acid, for instance, those having a relative molar mass of 500 to 70,000 g/mol.

Within the scope of this document, the molecular masses indicated for the polymeric carboxylates are weight-averaged molecular weights M_{W} of the appertaining acid form, which were fundamentally ascertained by means of gel-permeation chromatography (GPC), a process in which a UV detector was employed. In this context, the measurement was made with reference to an external polyacrylic acid standard which, due to its structural affinity to the polymers being examined, yields realistic molecular weight values. These results diverge markedly from the molecular weight results for which polystyrene sulfonic acids were employed as the standard. As a rule, the molecular masses measured with reference to polystyrene sulfonic acids are considerably higher than the molecular masses indicated in the present document.

Suitable polymers are, in particular, polyacrylates that preferably have a molar mass ranging from 2000 to 20,000 g/mol. Among this group, in turn, short-chain polyacrylates that have molar masses ranging from 2000 to 10,000 g/mol, and especially preferred from 3000 to 5000 g/mol, can be preferred due to their superior solubility.

Copolymeric polycarboxylates are likewise suitable, especially those of acrylic acid with methacrylic acid and of acrylic acid or methacrylic acid with maleic acid. Copolymers of acrylic acid with maleic acid containing 50% to 90% by weight of acrylic acid and 50% to 10% by weight of maleic acid have proven to be particularly well-suited. Their relative molar mass, relative to free acids, usually amounts to 2000 to 70,000 g/mol, preferably 20,000 to 50,000 g/mol and particularly 30,000 to 40,000 g/mol.

The (co-)polymeric polycarboxylates can be used either as powder or as an aqueous solution. The content of (co-)polymeric polycarboxylates in the washing or detergent compositions preferably ranges from 0.5% to 20% by weight and especially from 3% to 10% by weight.

For purposes of improving the water solubility, the polymers can also contain allyl sulfonic acids such as, for example, allyl oxybenzene sulfonic acid and methallyl sulfonic acid as the monomer.

Particularly preferred are also biodegradable polymers made up of more than two different monomer units, for instance, those that, as monomers, contain salts of acrylic acid and of maleic acid as well as vinyl alcohol or vinyl alcohol derivatives or that, as monomers, contain the salts of acrylic acid and of 2-alkylallyl sulfonic acid, as well as sugar derivatives.

Other preferred copolymers are those containing acrolein and acrylic acid/acrylic acid salts or acrolein and vinyl acetate as monomers.

Polymers that act as softeners are, for example, polymers containing sulfonic acid groups, whose use is particularly preferred.

As the polymers containing sulfonic acid groups, special preference is given to the use of copolymers made up of unsaturated carboxylic acids, monomers containing sulfonic acid groups and, optionally, other ionogenic or non-ionogenic monomers.

Preferred monomers within the scope of the present invention are unsaturated carboxylic acids having the formula

R¹(R²)C═C(R³)COOH,

wherein R¹ to R³, independently of each other, stand for —H, —CH₃, for a straight-chain or branched saturated alkyl radical having 2 to 12 carbon atoms, for a straight-chain or branched, monounsaturated or polyunsaturated alkenyl radical having 2 to 12 carbon atoms, with —NH₂, —OH or —COOH substituted alkyl or alkenyl radicals, or for —COOH or —COOR⁴, whereby R⁴ stands for a saturated or unsaturated, straight-chain or branched hydrocarbon radical having 1 to 12 carbon atoms.

Among the unsaturated carboxylic; acids that can be described by the formula above, special preference is given to acrylic acid (R¹═R²═R³═H), methacrylic acid (R¹═R²═H; R³═CH₃) and/or maleic acid (R¹═COOH; R²═R³═H).

When it comes to the monomers containing sulfonic acid groups, preference is given to those having the formula

R⁵(R⁶)C═C(R⁷)—X—SO₃H,

wherein R⁵ to R⁷, independently of each other, stand for —H, —CH₃, for a straight-chain or branched saturated alkyl radical having 2 to 12 carbon atoms, for a straight-chain or branched, monounsaturated or polyunsaturated alkenyl radical having 2 to 12 carbon atoms, with —NH₂, —OH or —COOH substituted alkyl or alkenyl radicals, or for —COOH or —COOR⁴, whereby R⁴ stands for a saturated or unsaturated, straight-chain or branched hydrocarbon radical having 1 to 12 carbon atoms, and X stands for an optionally present spacer group that is selected from among —(CH₂)ₙ— wherein n=0 to 4, —COO—(CH₂)ₖ— wherein k=1 to 6, —C(O)—NH—C(CH₃)₂— and —C(O)—NH—CH(CH₂CH₃)—.

Among these monomers, preference is given to those having the formulas

H₂C═CH—X—SO₃H

H₂C═C(CH₃)—X—SO₃H

HO₃S—X—(R⁶)C═C(R⁷)—X—SO₃H,

wherein R⁶ and R⁷, independently of each other, are selected from among —H, —CH₃, —CH₂CH₃, —CH₂CH₂CH₃, —CH(CH₃)₂, and X stands for an optionally present spacer group that is selected from among —(CH₂)ₙ— wherein n=0 to 4, —COO—(CH₂)ₖ— wherein k=1 to 6, —C(O)—NH—C(CH₃)₂— and —C(O)—NH—CH(CH₂CH₃)—.

Especially preferred monomers containing sulfonic acid groups in this context are 1-acrylamido-1-propane sulfonic acid, 2-acrylamido-2-propane sulfonic acid, 2-acrylamido-2-methyl-1-propane sulfonic acid, 2-methacrylamido-2-methyl-1-propane sulfonic acid, 3-methacrylamido-2-hydroxy propane sulfonic acid, allyl sulfonic acid, methallyl sulfonic acid, allyloxybenzene sulfonic acid, methallyloxy-benzene sulfonic acid, 2-hydroxy-3-(2-propenyloxy)propane sulfonic acid, 2-methyl-2-propene-1-sulfonic acid, styrene sulfonic acid, vinyl sulfonic acid, 3-sulfopropylacrylate, 3-sulfopropylmethacrylate, sulfomethacrylamide, sulfomethyl methacrylamide as well as water-soluble salts of the cited acids.

Other suitable ionogenic or non-ionogenic monomers are especially ethylenically unsaturated compounds. The content of these other ionogenic or non-ionogenic monomers in the polymers employed is preferably less than 20% by weight, relative to the polymer. The particularly preferably used polymers consist only of monomers having the formula R¹(R²)C═C(R³)COOH and of monomers having the formula R⁵(R⁶)C═C(R⁷)—X—SO₃H.

In summary, special preference is given to copolymers consisting of
i) unsaturated carboxylic acids having the formula R¹(R²)C═C(R³)COOH, wherein R¹ to R³, independently of each other, stand for —H, —CH₃, for a straight-chain or branched saturated alkyl radical having 2 to 12 carbon atoms, for a straight-chain or branched, monounsaturated or polyunsaturated alkenyl radical having 2 to 12 carbon atoms, with —NH₂, —OH or —COOH substituted alkyl or alkenyl radicals as defined above, or for —COOH or —COOR⁴ wherein R⁴ stands for a saturated or unsaturated, straight-chain or branched hydrocarbon radical having 1 to 12 carbon atoms;
ii) monomers containing sulfonic acid groups and having the formula

R⁵(R⁶)C═C(R⁷)—X—SO₃H,

wherein R⁶ to R⁷, independently of each other, stand or —H, —CH₃, for a straight-chain or branched saturated alkyl radical having 2 to 12 carbon atoms, for a straight-chain or branched, monounsaturated or polyunsaturated alkenyl radical having 2 to 12 carbon atoms, with —NH₂, —OH or —COOH substituted alkyl or alkenyl radicals as defined above, or for —COOH or —COOR⁴, wherein R⁴ stands for a saturated or unsaturated, straight-chain or branched hydrocarbon radical having 1 to 12 carbon atoms, and X stands for an optionally present spacer group that is selected from among —(CH₂)ₙ— wherein n=0 to 4, —COO—(CH₂)ₖ— wherein k=1 to 6, —C(O)—NH—C(CH₃)₂— and —C(O)—NH—CH(CH₂CH₃)—;
iii) optionally, additional ionogenic or non-ionogenic monomers.

Additional especially preferred copolymers consist of
i) one or more unsaturated carboxylic acids from among the group of acrylic acid, methacrylic acid and/or maleic acid;
ii) one or more monomers containing sulfonic acid groups and having the formulas

H₂C═CH—X—SO₃H

H₂C═C(CH₃)—X—SO₃H

HO₃S—X—(R⁶)C═C(R⁷)—X—SO₃H,

wherein R⁶ and R⁷, independently of each other, stand for —H, —CH₃, —CH₂CH₃, —CH₂CH₂CH₃, —CH(CH₃)₂, and X stands for an optionally present spacer group that is selected from among —(CH₂)ₙ— wherein n=0 to 4, —COO—(CH₂)ₖ— wherein k=1 to 6, —C(O)—NH—C(CH₃)₂— and —C(O)—NH—CH(CH₂CH₃)—;
iii) optionally, additional ionogenic or non-ionogenic monomers.

The copolymers can contain the monomers from groups i) and ii) as well as, optionally, iii) in varying amounts, whereby any representative of group i) can be combined with any representative of group ii) and with any representative of group iii). Especially preferred polymers have certain structural units that will be described below.

Thus, for instance, preference is given to copolymers containing structural units having the formula

—[CH₂—CHCOOH]ₘ—[CH₂—CHC(O)—Y—SO₃H]ₚ—,

wherein m and p each stand for a whole natural number between 1 and 2000 and Y stands for a spacer group that is selected from among substituted or unsubstituted aliphatic, aromatic or substituted aromatic hydrocarbon radicals having 1 to 24 carbon atoms, whereby preference is given to spacer groups in which Y stands for —O—(CH₂)ₙ— wherein n=0 to 4, for —O—(C₆H₄)—, for —NH—C(CH₃)₂— or for —NH—CH(CH₂OH₃)—

These polymers are produced by copolymerization of acrylic acid with an acrylic acid derivative containing sulfonic acid groups. When the acrylic acid derivative containing sulfonic acid groups is copolymerized with methacrylic acid, one obtains a different polymer whose use is likewise preferred. The corresponding copolymers contain the structural units having the formula

—[CH₂—C(CH₃)COOH]ₘ—[CH₂—CHC(O)—Y—SO₃H]ₚ—,

wherein m and p each stand for a whole natural number between 1 and 2000 and Y stands for a spacer group that is selected from among substituted or unsubstituted aliphatic, aromatic or substituted aromatic hydrocarbon radicals having 1 to 24 carbon atoms, whereby preference is given to spacer groups in which Y stands for —O—(CH₂)ₙ— wherein n=0 to 4, for —O—(C₆H₄)—, for —NH—C(CH₃)₂— or for —NH—CH(CH₂CH₃)—.

In a completely analogous manner, acrylic acid and/or methacrylic acid can also be copolymerized with methacrylic acid derivatives containing sulfonic acid groups, as a result of which the structural units in the molecule are modified. Thus preference is given to copolymers containing structural units having the formula

—[CH₂—CHCOOH]ₘ—[CH₂—C(CH₃)C(O)—Y—SO₃H]ₚ—,

wherein m and p each stand for a whole natural number between 1 and 2000 and Y stands for a spacer group that is selected from among substituted or unsubstituted aliphatic, aromatic or substituted aromatic hydrocarbon radicals having 1 to 24 carbon atoms, whereby special preference is given to spacer groups in which Y stands for —O—(CH₂)ₙ— wherein n=0 to 4, for —O—(C₆H₄)—, for —NH—C(CH₃)₂— or for —NH—CH(CH₂CH₃)—; likewise preferred are copolymers containing structural units having the formula

—[CH₂—C(CH₃)COOH]ₘ—[CH₂—C(CH₃)C(O)—Y—SO₃H]ₚ—,

wherein m and p each stand for a whole natural number between 1 and 2000 and Y stands for a spacer group that is selected from among substituted or unsubstituted aliphatic, aromatic or substituted aromatic hydrocarbon radicals having 1 to 24 carbon atoms, whereby preference is given to spacer groups in which Y stands for —O—(CH₂)ₙ— wherein n=0 to 4, for —O—(C₆H₄)—, for —NH—C(CH₃)₂— or for —NH—CH(CH₂CH₃)—.

Instead of acrylic acid and/or methacrylic acid or else as a complement thereto, maleic acid can also be used as a particularly preferred monomer from group i). This yields copolymers that are preferred according to the invention containing the structural units having the formula

—[HOOCCH—CHCOOH]ₘ—[CH₂—CHC(O)—Y—SO₃H]ₚ—,

wherein m and p each stand for a whole natural number between 1 and 2000 and Y stands for a spacer group that is selected from among substituted or unsubstituted aliphatic, aromatic or araliphatic hydrocarbon radicals having 1 to 24 carbon atoms, whereby preference is given to spacer groups in which Y stands for —O—(CH₂)ₙ— wherein n=0 to 4, for —O—(C₆H₄)—, for —NH—C(CH₃)₂— or for —NH—CH(CH₂CH₃)—. Likewise preferred according to the invention are copolymers containing structural units having the formula

—[HOOCCH—CHCOOH]ₘ—[CH₂—C(CH₃)C(O)O—Y—SO₃H]ₚ—,

wherein m and p each stand for a whole natural number between 1 and 2000 and Y stands for a spacer group that is selected from among substituted or unsubstituted aliphatic, aromatic or substituted aromatic hydrocarbon radicals having 1 to 24 carbon atoms, whereby preference is given to spacer groups in which Y stands for —O—(CH₂)ₙ— wherein n 0 to 4, for —O—(C₆H₄)—, for —NH—C(CH₃)₂— or for —NH—CH(CH₂CH₃)—.

In summary, special preference is given according to the invention to copolymers containing structural units having the formulas

—[CH₂—CHCOOH]ₘ—[CH₂—CHC(O)—Y—SO₃H]ₚ—

—[CH₂—C(CH₃)COOH]ₘ—[CH₂—CHC(O)—Y—SO₃H]ₚ—

—[CH₂—CHCOOH]ₘ—[CH₂—C(CH₃)C(O)—Y—SO₃H]ₚ—

—[CH₂—C(CH₃)COOH]ₘ—[CH₂—C(CH₃)C(O)—Y—SO₃H]ₚ—

—[HOOCCH—CHCOOH]ₘ—[CH₂—CHC(O)—Y—SO₃H]ₚ—

—[HOOCCH—CHCOOH]ₘ—[CH₂—C(CH₃)C(O)O—Y—SO₃H]ₚ—,

wherein m and p each stand for a whole natural number between 1 and 2000 and Y stands for a spacer group that is selected from among substituted or unsubstituted aliphatic, aromatic or substituted aromatic hydrocarbon radicals having 1 to 24 carbon atoms, whereby preference is given to spacer groups in which Y stands for —O—(CH₂)ₙ— wherein n=0 to 4, for —O—(C₆H₄)—, for —NH—C(CH₃)₂— or for NH—CH(CH₂CH₃)—.

The sulfonic acid groups can be completely or partially present in the polymers in a neutralized form, that is to say, the acidic hydrogen atom of the sulfonic acid group in some or in all of the sulfonic acid groups can be exchanged for metal ions, preferably alkali metal ions and especially for sodium ions. The use of partially or completely neutralized copolymers containing sulfonic acid groups is preferred according to the invention.

In the case of copolymers that contain only monomers of groups i) and ii), the monomer distribution of the copolymers preferably employed according to the invention is preferably 5% to 95% by weight of i) or ii), especially preferred 50% to 90% by weight of monomers from group i) and 10% to 50% by weight of monomers from group i) and 10% to 50% by weight of monomers from group ii), each time relative to the polymer.

In the case of terpolymers, special preference is given to those that contain 20% to 85% by weight of monomers from group i), 10% to 60% by weight of monomers from group ii) as well as 5% to 30% by weight of monomers from group iii).

The molar mass of the sulfo-copolymers preferably employed according to the invention can be varied in order to adapt the properties of the polymers to the envisaged application purpose. Preferred washing or detergent compositions are characterized in that the copolymers have molar masses ranging from 2000 to 200,000 gmol⁻¹, preferably from 4000 to 25,000 gmol⁻¹ and especially from 5000 to 15,000 gmol⁻¹.

As other preferred builder substances, mention should also be made of polymeric amino dicarboxylic acids, their salts or their precursor substances. Especially preferred are polyaspartic acids or their salts.

Other suitable builder substances are polyacetals that can be obtained by reacting dialdehydes with polycarboxylic acids having 5 to 7 carbon atoms and at least 3 hydroxyl groups, Preferred polyacetals are obtained from dialdehydes such as glyoxal, glutaraldehyde, terephthaldehyde as well as their mixtures and from polyol carboxylic acids such as gluconic acid and/or glucoheptonic acid.

Other suitable organic builder substances are dextrins, for instance, oligomers or polymers of carbohydrates that can be obtained through the partial hydrolysis of starches. The hydrolysis can be performed by means of conventional methods, for instance, acid-catalyzed or enzyme-catalyzed methods. Preferably, these are hydrolysis products having mean molar masses within the range from 400 to 500,000 g/mol. In this context, a polysaccharide having a dextrose equivalent (DE) within the range from 0.5 to 40, especially from 2 to 30 is preferred, whereby DE is a customary measure of the reducing effect of a polysaccharide in comparison to dextrose, which has a DE of 100. It is likewise possible to use maltodextrins having a DE between 3 and 20 and dry glucose syrup having a DE between 20 and 37 as well as so-called yellow dextrins and white dextrins having higher molar masses within the range from 2000 to 30,000 g/mol.

The oxidized derivatives of such dextrins are their reaction products with oxidants that are capable of oxidizing at least one alcohol function of the saccharide ring to create the carboxylic acid function.

Oxydisuccinates and other derivatives of disuccinates, preferably ethylene diamine disuccinate, constitute other suitable co-builders. Here, ethylene diamine-N-N′-disuccinate (EDDS) is preferably employed in the form of its sodium salts or magnesium salts. Likewise preferred in this context are glycerin disuccinate and glycerin trisuccinate. Suitable amounts to be used are 3% to 15% by weight in formulations containing zeolite and/or silicate.

Other useable organic co-builders are, for example, acetylated hydroxy carboxylic acids or their salts, which can optionally be present in lactone form and which contain at least 4 carbon atoms and at least one hydroxy group as well as two acid groups at the maximum.

Moreover, all compounds capable of forming complexes with earth-alkali ions can also be employed as detergent builders.

The group of surfactants includes the non-ionic, the anionic, the cationic and the amphoteric surfactants.

All of the non-ionic surfactants known to the person skilled in the art can be used as the non-ionic surfactants. Examples of suitable non-ionic surfactants are alkyl glycosides having the general formula RO(G)ₓ, wherein R stands for a primary straight-chain or methyl-branched aliphatic radical—especially one that is methyl-branched in the 2 position—having 8 to 22, preferably 12 to 18, carbon atoms and wherein G is the symbol that stands for a glycose unit having 5 or 6 carbon atoms, preferably for glucose. The degree of oligomerization x, which indicates the distribution of monoglycosides and oligoglycosides, is any desired number between 1 and 10; preferably x is 1.2 to 1.4.

Another class of preferably used non-ionic surfactants that can be employed either as the sole non-ionic surfactant or else in combination with other non-ionic surfactants comprises alkoxylated, preferably ethoxylated or ethoxylated and propoxylated fatty acid alkyl esters, preferably having 1 to 4 carbon atoms in the alkyl chain.

Likewise suitable are non-ionic surfactants of the aminoxide type, for instance, N-coconut-alkyl-N,N-dimethyl aminoxide and N-tallow-alkyl-N,N-dihydroxy ethyl aminoxide as well as the fatty acid alkanol amides. The amount of these non-ionic surfactants is preferably not more than that of the ethoxylated fatty alcohols, particularly not more than half thereof.

Other suitable surfactants are polyhydroxy fatty acid amides having the formula

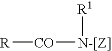

wherein R stands for an aliphatic acyl radical having 6 to 22 carbon atoms, R¹ stands for hydrogen, for an alkyl or hydroxyalkyl radical having 1 to 4 carbon atoms and [Z] stands for a linear or branched polyhydroxy alkyl radical having 3 to 10 carbon atoms and 3 to 10 hydroxyl groups. The polyhydroxy fatty acid amides are known substances that can normally be obtained through reductive amination of a reducing sugar with ammonia, with an alkyl amine or with an alkanol amine, followed by acylation with a fatty acid, with a fatty acid alkyl ester or with a fatty acid chloride.

The group of polyhydroxy fatty acid amides also includes compounds having the formula

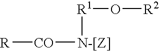

wherein R stands for a linear or branched alkyl or alkenyl radical having 7 to 12 carbon atoms, R¹ stands for a linear, branched or cyclic alkyl radical or for an aryl radical having 2 to 8 carbon atoms and R¹² stands for a linear, branched or cyclic alkyl radical or for an aryl radical or oxyalkyl radical having 1 to 8 carbon atoms, whereby C₁₄-alkyl radicals or phenyl radicals are preferred, and [Z] stands for a linear polyhydroxy alkyl radical whose alkyl chain is substituted with at least two hydroxyl groups, or for alkoxylated, preferably ethoxylated or propoxylated derivatives of this radical.

[Z] is preferably obtained through reductive amination of a reducing sugar, for example, glucose, fructose, maltose, lactose, galactose, mannose or xylose. The N-alkoxy-substituted or N-aryloxy-substituted compounds can be converted into the desired polyhydroxy fatty acid amides by reacting them with fatty acid methyl esters in the presence of an alkoxide as the catalyst.

Low-foaming, non-ionic surfactants are employed as the preferred surfactants. It is particularly preferred for the washing or detergent compositions, especially the detergents for dishwashers, to contain non-ionic surfactants from the group of alkoxylated alcohols. As the non-ionic surfactants, preference is given to the use of alkoxylated, advantageously ethoxylated, especially primary alcohols, preferably having 8 to 18 carbon atoms and an average of 1 to 12 moles of ethylene oxide (EO) per mole of alcohol, in which the alcohol radical can be linear or preferably methyl-branched in the 2-position or else can contain linear and methyl-branched radicals in the mixture, of the type that is normally present in oxoalcohol radicals. In particular, however, preference is given to alcohol ethoxylates having linear radicals coming from alcohols of native origin having 12 to 18 carbon atoms, for example, from coconut alcohol, palm alcohol, tallow fat alcohol or oleyl alcohol, and an average of 2 to 8 moles of EO per mole of alcohol. The preferred ethoxylated alcohols include, for instance, C₁₂₋₁₄-alcohols with 3 EO or 4 EO, C₉₋₁₁-alcohol with 7 EO, C₁₃₋₁₅-alcohols with 3 EO, 5 EO, 7 EO or 8 EO, C₁₂₋₁₈-alcohols with 3 EO, 5 EO or 7 EO as well as mixtures thereof, such as mixtures consisting of C₁₂₋₁₄-alcohol with 3 EO and C₁₂₋₁₈-alcohol with 5 EO. The degrees of ethoxylation indicated constitute statistical mean values that, for a specific product, can correspond to a whole number or a fraction. Preferred alcohol ethoxylates have a narrowed homolog distribution (narrow range ethoxylates —NRE). In addition to these non-ionic surfactants, it is also possible to use fatty alcohols with more than 12 EO. Examples of these are tallow fat alcohol with 14 EO, 25 EO, 30 EO or 40 EO.

Particular preference is given to ethoxylated non-ionic surfactants which were obtained from C₆₋₂₀-monohydroxy alkanols or C₆₋₂₀-alkyl phenols or C₁₆₋₂₀-fatty alcohols and more than 12 moles, preferably more than 15 moles and especially more than 20 moles, of ethylene oxide per mole of alcohol. An especially preferred non-ionic surfactant is obtained from a straight-chain fatty alcohol having 16 to 20 carbon atoms (C₁₆₋₂₀-alcohol), preferably an C₁₈-alcohol and at least 12 moles, preferably at least 15 moles and especially at least 20 moles of ethylene oxide. Among these, special preference is given to the so-called narrow range ethoxylates.

Especially preferred is also the use of combinations of one or more tallow fat alcohols with 20 to 30 EO and silicone de-foaming agents.

Particularly preferred are non-ionic surfactants having a melting point above the room temperature. Non-ionic surfactant(s) having a melting point above 20° C. [68° F.], preferably above 25° C. [77° F.], especially preferred between 25° C. and 60° C. [77° F. and 140° F.] and particularly between 26.6° C. and 43.3° C. [79.88° F. and 109.94° F.], is/are especially preferred.

Suitable non-ionic surfactants having melting points or softening points in the above-mentioned temperature ranges are, for instance, low-foaming non-ionic surfactants that can be solid or highly viscous at room temperature. When non-ionic surfactants that are highly viscous at room temperature are used, it is preferable for them to have a viscosity above 20 Pa·s, preferably above 35 Pa·s and particularly above 40 Pa·s. Depending on the application purpose, preference is also given to non-ionic surfactants that have a waxy consistency at room temperature.

Non-ionic surfactants from the group of alkoxylated alcohols especially preferably from the group of the mixed alkoxylated alcohols and particularly from the group of the EO-AO-EO non-ionic surfactants are likewise used with special preference.

The non-ionic surfactant that is solid at room temperature preferably contains propylene oxide units in the molecule. Preferably, such PO units account for up to 25% by weight, especially preferably up to 20% by weight, and especially up to 15% by weight, of the total molecular mass of the non-ionic surfactant. Especially preferred non-ionic surfactants are ethoxylated monohydroxy alkanols or alkyl phenols that additionally contain polyoxyethylene-polyoxypropylene block copolymer units. The alcohol or alkyl phenol fraction of such non-ionic surfactant molecules preferably amounts to more than 30% by weight, especially preferably more than 50% by weight and particularly more than 70% by weight, of the total molecular mass of such non-ionic surfactants. The preferred compositions are characterized in that they contain ethoxylated and propoxylated non-ionic surfactants in which the propylene oxide units in the molecule account for up to 25% by weight, preferably up to 20% by weight, and particularly up to 15% by weight, of the total molecular mass of the non-ionic surfactant.

The surfactants that are preferably to be employed come from the groups of the alkoxylated non-ionic surfactants, especially of the ethoxylated primary alcohols and mixtures of these surfactants having structurally complicated surfactants such as polyoxypropylene/polyoxyethylene/polyoxypropylene ((PO/EO/PO) surfactants). Such (PO/EO/PO) non-ionic surfactants) are also characterized by good foaming control.

Other especially preferably used non-ionic surfactants having melting points above room temperature contain 40% to 70% by weight of a polyoxypropylene/polyoxyethylene/polyoxypropylene block polymer blend containing 75% by weight of a reverse block copolymer of polyoxyethylene and polyoxypropylene with 17 moles of ethylene oxide and 44 moles of propylene oxide and 25% by weight of a block copolymer of polyoxyethylene and polyoxypropylene, initiated with trimethylol propane and containing 24 moles of ethylene oxide and 99 moles of propylene oxide per mole of trimethylol propane.

Low-foaming non-ionic surfactants having alternating ethylene oxide and alkylene oxide units have proven to be particularly preferred non-ionic surfactants within the scope of the present invention. Among these, in turn, preference is given to surfactants having EO-AO-EO-AO blocks, whereby one to ten EO or AO groups are bonded to each other in each case, before a block of the corresponding other group follows. Here, preference is given to non-ionic surfactants having the general formula

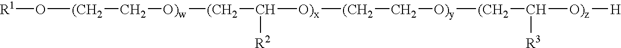

wherein R¹ stands for a straight-chain or branched, saturated or monounsaturated or polyunsaturated C₆₋₂₄-alkyl radical or C₆₋₂₄-alkenyl radical; each group R² or R³, independently of each other, is selected from among —CH₃, —CH₂CH₃, —CH₂CH₂—CH₃, CH(CH₃)₂, and the indices w, x, y, z, independently of each other, stand for whole numbers from 1 to 6.

The preferred non-ionic surfactants having the formula above can be produced from the corresponding alcohols R¹—OH and ethylene oxide or alkylene oxide by means of known methods. The radical R¹ in the formula above can vary depending on the origin of the alcohol. If native sources are utilized, the radical R¹ has an even number of carbon atoms and is unbranched as a rule, whereby preference is given to the linear radicals from alcohols of a native origin having 12 to 18 carbon atoms, for example, from coconut alcohol, palm alcohol, tallow fat alcohol or oleyl alcohol. Alcohols obtainable from synthetic sources are; for instance, the Guerbet alcohols, or radicals that are methyl-branched or linear and methyl-branched in the 2-position in a mixture, of the kind normally present in oxoalcohol radicals. Irrespective of the type of alcohol employed for the production of the non-ionic surfactants contained in the compositions, preference is given to non-ionic surfactants in which R¹ in the formula above stands for an alkyl radical having 6 to 24, preferably 8 to 20, especially preferably 9 to 15, and particularly 9 to 11, carbon atoms.

Aside from propylene oxide, especially butylene oxide is a possibility as the alkylene oxide unit that is contained in the preferred non-ionic surfactants as an alternative to the ethylene oxide unit. However, alkylene oxides in which R² or R³, independently of each other, is selected from among —CH₂CH₂—CH₃ or —CH(CH₃)₂ are also suitable. Preference is also given to non-ionic surfactants having the formula above in which R² or R³ stands for a —CH₃ radical, w and x, independently of each other, stand for values of 3 or 4, and y and z, independently of each other, stand for values of 1 or 2.

In summary, special preference is given to non-ionic surfactants that have a C₉₋₁₅-alkyl radical having 1 to 4 ethylene oxide units, followed by 1 to 4 propylene oxide units, followed by 1 to 4 ethylene oxide units, followed by 1 to 4 propylene oxide units. These surfactants have the requisite low viscosity in an aqueous solution and, according to the invention, are given special preference for use.

According to the invention, preference is given to surfactants having the general formula R¹—CH(OH)CH₂O-(AO)_{w}-(A′O)ₓ-(A″O)_{y}-(A′″O)_{z}—R², wherein R¹ and R², independently of each other, stand for a straight-chain or branched, saturated or monounsaturated or polyunsaturated C₂₋₄₀-alkyl radical or C₂₋₄₀-alkenyl radical; A, A′, A″, A′″, independently of each other, stand for a radical from the group of —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z stand for values between 0.5 and 90, whereby x, y and/or z can also be 0.

Particularly preferred are those poly(oxylalkylated) non-ionic surfactants that are terminal-group-closed and have the formula R¹O[CH₂CH₂O]ₓCH₂CH(OH)R² and, aside from a radical R¹ that stands for linear or branched, saturated or unsaturated, aliphatic or aromatic hydrocarbon radicals having 2 to 30 carbon atoms, preferably having 4 to 22 carbon atoms, also a linear or branched, saturated or unsaturated, aliphatic or aromatic hydrocarbon radical R² having 1 to 30 carbon atoms, whereby x stands for values between 1 and 90, preferably for values between 30 and 80 and especially for values between 30 and 60.

Especially preferred are surfactants having the formula R¹O[CH₂CH(CH₃)O]ₓ [CH₂CH₂O]_{y}CH₂CH(OH)R², wherein R¹ stands for a linear or branched aliphatic hydrocarbon radical having 4 to 18 carbon atoms or mixtures thereof, R² stands for a linear or branched hydrocarbon radical having 2 to 26 carbon atoms or mixtures thereof, and x stands for values between 0.5 and 1.5, and y stands for a value of at least 15.

Likewise especially preferred are those poly(oxylalkylated) non-ionic surfactants that are terminal-group-closed and have the formula R¹O[CH₂CH₂O]ₓ [CH₂CH(R³)O]_{y}CH₂CH(OH)R², wherein R¹ and R², independently of each other, stand for a linear or branched, saturated or monounsaturated or polyunsaturated hydrocarbon radical having 2 to 26 carbon atoms, R³, independently of each other, is selected from among —CH₃, —CH₂CH₃, —CH₂CH₂—CH₃, —CH(CH₃)₂, preferably, however, for —CH₃, and x and y, independently of each other, stand for values between 1 and 32, whereby special preference is given to non-ionic surfactants, wherein R³=—CH₃ and wherein x has values ranging from 15 to 32 and y has values ranging from 0.5 to 1.5.

Other preferred useable non-ionic surfactants are those that are terminal-group-closed and have the formula R¹O[CH₂CH(R³)O]ₓ[CH₂]ₖCH(OH)[CH₂]ⱼOR², wherein R¹ and R² stand for linear or branched, saturated or unsaturated, aliphatic or aromatic hydrocarbon radicals having 1 to 30 carbon atoms, R³ stands for H or for a methyl, ethyl, n-propyl, iso-propyl, n-butyl, 2-butyl or 2-methyl-2-butyl radical, x stands for values between 1 and 30, k and j stand for values between 1 and 12, preferably between 1 and 5. If x≧2, each R³ in the formula R¹O[CH₂CH(R³)O]ₓ [CH₂]ₖCH(OH)[CH₂]ⱼOR² above can be different. R¹ and R² are preferably linear or branched, saturated or unsaturated, aliphatic or aromatic hydrocarbon radicals having 6 to 22 carbon atoms, whereby radicals having 8 to 18 carbon atoms are especially preferred. For the radical R³, special preference is given to H, —CH₃ or —CH₂CH₃. The particularly preferred values for x are within the range from 1 to 20, especially from 6 to 15.

As described above, each R³ in the formula above can be different if x≧2. As a result, the alkylene oxide unit in the square brackets can be varied. If x stands, for example, for 3, the R³ radical can be selected in order to form ethylene oxide units (R³═H) or propylene oxide units (R³═CH₃) which can be joined to each other in any desired sequence, for instance, (EO)(PO)(EO), (EO)(EO)(PO), (EO)(EO)(EO), (PO)(EO)(PO), (PO)(PO)(EO) and (PO)(PO)(PO). The value of 3 for x has been chosen here by way of an example and can certainly be higher, whereby the variation spectrum increases as the x values rise and includes, for instance, a large number of (EO) groups, combined with a small number of (PO) groups, or vice versa.

Especially preferred poly(oxylalkylated) alcohols that are terminal-group-closed and have the formula above have values of k=1 and j=1, so that the formula above is simplified to R¹O[CH₂CH(R³)O]ₓCH₂CH(OH)CH₂OR². In the latter formula, R¹, R² and R¹³ are as defined above, and x stands for numbers ranging from 1 to 30, preferably from 1 to 20, and especially from 6 to 18. Special preference is given to surfactants wherein the radicals R¹ and R² have 9 to 14 carbon atoms, R³ stands for H and x for values ranging from 6 to 15.

The indicated carbon chain lengths and degrees of ethoxylation or degrees of alkoxylation of the above-mentioned non-ionic surfactants are statistical mean values that, for a specific product, can be a whole number or a fraction. Owing to the production method, commercial products having the cited formulas usually do not consist of an individual representative, but rather of mixtures, as a result of which mean values and fractions coming from these can result for the carbon chain lengths as well as for the degrees of ethoxylation or degrees of alkoxylation.

Of course, the above-mentioned non-ionic surfactants can be employed not only as individual substances, but also as surfactant mixtures made up of two, three, four or more surfactants. Surfactant mixtures here do not refer to mixtures of non-ionic surfactants that, in their totality, fall under one of the above-mentioned general formulas, but rather, to those mixtures containing two, three, four or more non-ionic surfactants that can be described by various of the above-mentioned general formulas.

If anionic surfactants are employed as ingredients of detergents for dishwashers, then their content is preferably less than 4% by weight, preferred less than 2% by weight and particularly preferably less than 1% by weight, relative to the total weight of the compositions. Special preference is given to dishwasher detergents that do not contain any anionic surfactants.

Instead of the cited surfactants or in conjunction with these, it is also possible to use cationic and/or amphoteric surfactants.

Examples of cationic active substances that can be used are cationic compounds having the following formulas:

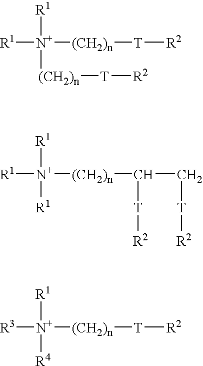

wherein each R¹ group, independently of each other, is selected from among C₁₋₆-alkyl, CO₁₋₆-alkenyl or C₁₋₆-hydroxyalkyl groups; each R² group, independently of each other, is selected from among C₈₋₂₈-alkyl or C₈₋₂₈-alkenyl groups; R³═R¹or (CH₂)ₙ-T-R²; R⁴═R¹ or R² or (CH₂)ₙ-T-R²; T=—CH₂—, —O—CO— or —CO—O—, and n is a whole number from 0 to 5.

In dishwasher detergents, the content of cationic and/or amphoteric surfactants is preferably less than 6% by weight, preferred less than 4% by weight, especially preferred less than 2% by weight and particularly less than 1% by weight. Particular preference is given to dishwasher detergents that do not contain any cationic or amphoteric surfactants.

### Polymers

The group of polymers especially includes washing-active or detergent-active polymers, for instance, rinse-agent polymers and/or polymers that act as water softeners. Generally, aside from non-ionic polymers, it is also possible to employ cationic, anionic and amphoteric polymers in the washing or detergent compositions.

The term “cationic polymers” as employed in the present invention refers to polymers that have a positive charge in the polymer molecule. This charge can be created, for instance, by (alkyl)ammonium groupings or other positively charged groups present in the polymer chain. Especially preferred cationic polymers come from the groups of the quaternated cellulose derivatives, of the polysiloxanes with quaternary groups, of the cationic guar derivatives, of the polymeric dimethyl diallyl ammonium salts and their copolymers with esters and amides of acrylic acid and methacrylic acid, of the copolymers of vinyl pyrrolidone with quaternated derivatives of dialkyl amino acrylate and dialkyl amino methacrylate, of the vinyl pyrrolidone-methoimidazolinium-chloride copolymers, of the quaternated polyvinyl alcohols or of the polymers that fall under the INCI designations polyquaternium 2, polyquaternium 17, polyquaternium 18 and polyquaternium 27.

The term “amphoteric polymers” as employed in the present invention refers not only to a positively charged group in the polymer chain but also to negatively charged groups or monomer units. These groups can be, for instance, carboxylic acids, sulfonic acids or phosphonic acids.

Preferred washing or detergent compositions, especially preferred dishwasher detergents, are characterized in that they contain a polymer a) that has monomer units having the formula R¹R²C═CR³R⁴, wherein each R¹, R², R³, R⁴ radical, independently of each other, is selected from among hydrogen, a derivatized hydroxy group, C₁₋₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternated N atom or at least one amino group having a positive charge in the partial area of the pH range from 2 to 11, or salts thereof, with the proviso that at least one R¹, R², R³, R⁴ radical stands for a heteroatomic organic group having at least one positive charge without charged nitrogen, at least one quaternated N atom or at least one amino group having a positive charge.

Within the scope of the present invention, the especially preferred cationic or amphoteric polymers contain, as the monomer unit, a compound having the general formula

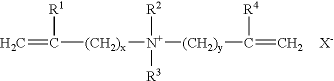

wherein R¹ and R⁴, independently of each other, stand for H or for a linear or branched hydrocarbon radical having 1 to 6 carbon atoms; R² and R³, independently of each other, stand for an alkyl, hydroxyalkyl or amino alkyl group in which the alkyl radical is linear or branched and has between 1 and 6 carbon atoms, whereby it is preferably a methyl group; x and y, independently of each other, stand for whole numbers between 1 and 3. X⁻ represents a counter ion, preferably a counter ion from the group comprising chloride, bromide, iodide, sulfate, hydrogen sulfate, methosulfate, lauryl sulfate, dodecyl benzene sulfonate, p-toluene sulfonate (tosylate), cumene sulfonate, xylene sulfonate, phosphate, citrate, formiate, acetate or their mixtures.

Preferred R¹ and R⁴ radicals in the formula above are selected from among —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃ and —(CH₂CH₂—O)ₙH.

Very special preference is given to polymers that have a cationic monomer unit having the general formula above, wherein R¹ and R⁴ stand for H, R² and R³ stand for methyl, and x and y are each 1. In the case of X⁻=chloride, the corresponding monomer units having the formula

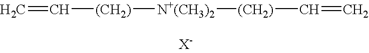

are also referred to as DADMAC (diallyl dimethyl ammonium chloride).

Other especially preferred cationic or amphoteric polymers contain a monomer unit having the general formula

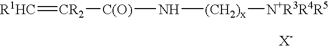

wherein R¹, R², R³, R⁴, R⁵, independently of each other, stand for a linear or branched, saturated or unsaturated alkyl or hydroxy alkyl radical having 1 to 6 carbon atoms, preferably for a linear or branched alkyl radical selected from among —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x stands for a whole number between 1 and 6.

Very especially preferred within the scope of the present application are polymers that have a cationic monomer unit having the above-mentioned general formula, wherein R¹ stands for H and R¹, R², R³, R⁴ and R⁵ stand for methyl and x stands for 3. In the case of X⁻=chloride, the corresponding monomer units having the formula

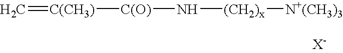

are also referred to as MAPTAC (methyl acrylamidopropyl-trimethyl ammonium-chloride).

According to the invention, preference is given to the use of polymers that contain diallyl dimethyl ammonium salts and/or acrylamidopropyl methyl ammonium salts as the monomer units.

The above-mentioned amphoteric polymers not only have cationic groups, but also anionic groups or monomer units. Such anionic monomer units come, for example, from the group of the linear or branched, saturated or unsaturated carboxylates, of the linear or branched, saturated or unsaturated phosphonates, of the linear or branched, saturated or unsaturated sulfates or of the linear or branched, saturated or unsaturated sulfonates. Preferred monomer units are acrylic acid, (meth)acrylic acid, (dimethyl)acrylic acid, (ethyl)acrylic acid, cyanoacrylic acid, vinyl acetic acid, allyl acetic acid, crotonic acid, maleic acid, fumaric acid, cinnamic acid and their derivatives, the allyl sulfonic acids such as, for example, allyl oxybenzene sulfonic acid and methallyl sulfonic acid or the allyl phosphonic acids.

Preferred amphoteric polymers that can be used come from the group of the alkyl acrylamide/acrylic acid copolymers, of the alkyl acrylamide/methacrylic acid copolymers, of the alkyl acrylamide/methyl methacrylic acid copolymers, of the alkyl acrylamide/acrylic acid/alkyl amino alkyl(meth)acrylic acid copolymers, of the alkyl acrylamide/methacrylic acid/alkyl amino alkyl(meth)acrylic acid copolymers, of the alkyl acrylamide/methyl methacrylic acid/alkyl amino alkyl(metha)acrylic acid copolymers, of the alkyl acrylamide/alkyl methacrylate/alkyl amino ethyl methacrylate/alkyl methacrylate copolymers as well as of the copolymers consisting of unsaturated carboxylic acids, cationically derivatized unsaturated carboxylic acids and, optionally, other ionic or non-ionogenic monomers.

Preferred zwitterionic polymers that can be used come from the group of the acrylamido alkyl trialkyl ammonium chloride/acrylic acid copolymers as well as their alkali salts and ammonium salts, of the acrylamido alkyl trialkyl ammonium chloride/methacrylic acid copolymers as well as their alkali salts and ammonium salts, as well as of the methacroyl ethyl betaine/methacrylate copolymers.

Likewise preferred are amphoteric polymers which, in addition to one or more ionic monomers, comprise methacrylamido alkyl trialkyl ammonium chloride and dimethyl (diallyl) ammonium chloride as cationic monomers.

Especially preferred amphoteric polymers come from the group of the methacrylamido alkyl trialkyl ammonium chloride/dimethyl (diallyl) ammonium chloride/acrylic acid copolymers, of the methacrylamido alkyl trialkyl ammonium chloride/dimethyl (diallyl) ammonium chloride/methacrylic acid copolymers and of the methacrylamido alkyl trialkyl ammonium chloride/dimethyl (diallyl) ammonium chloride/alkyl-(meth)acrylic acid copolymers as well as their alkali salts and ammonium salts.

Special preference is given to amphoteric polymers from the group consisting of the methacrylamido propyl trimethyl ammonium chloride/dimethyl (diallyl) ammonium chloride/acrylic acid copolymers, of the methacrylamido propyl trimethyl ammonium chloride/dimethyl (diallyl) ammonium chloride/acrylic acid copolymers and of the methacrylamido propyl trimethyl ammonium chloride/dimethyl (diallyl) ammonium chloride/alkyl(meth)acrylic acid copolymers as well as their alkali salts and ammonium salts.

In an especially preferred embodiment of the present invention, the polymers are present in pre-fabricated form. Suitable processes for the fabrication of the polymers are, among others:
the encapsulation of the polymers by means of water-soluble or water-dispersible coating agents, preferably by means of water-soluble or water-dispersible natural or synthetic polymers;
the encapsulation of the polymers by means of water-insoluble, meltable coating agents, preferably by means of water-insoluble coating agents from the group of waxes or paraffins having a melting point above 30° C. [86° F.];
the co-granulation of the polymers with inert carrier materials, preferably with carrier materials from the group of washing-active or detergent-active substances, especially preferably from the group of builders (detergent builders) or co-builders.

Washing or detergent compositions preferably contain the above-mentioned cationic and/or amphoteric polymers in amounts between 0.01% and 10% by weight, each time relative to the total weight of the washing or detergent composition. Within the scope of the present application, however, preference is given to those washing or detergent compositions in which the percentage by weight of the cationic and/or amphoteric polymers lies between 0.01% and 8% by weight, preferably between 0.01% and 6% by weight, preferred between 0.01% and 4% by weight, especially preferred between 0.01% and 2% by weight, particularly between 0.01% and 1% by weight, each time relative to the total weight of the dishwasher detergent.

The bleaching agents are a preferably used washing-active or detergent-active substance. Sodium percarbonate, sodium perborate tetrahydrate and sodium perborate monohydrate have acquired special significance as compounds that yield H₂O₂ in water and that serve as bleaching agents. Other useable bleaching agents are, for instance, peroxy pyrophosphates, citrate perhydrates as well as peracidic salts or peracids that yield H₂O₂, such as perbenzoates, peroxophthalates, diperazelaic acid, phthalimino peracid or diperdodecanoic diacid. Bleaching agents from the group of organic bleaching agents can also be employed. Typical organic bleaching agents are the diacyl peroxides, such as, for example, dibenzoyl peroxide. Other typical organic bleaching agents are peroxy acids, whereby especially the alkyl peroxy acids and the aryl peroxy acids can be cited as examples. Preferred representatives are (a) peroxy benzoic acid and its ring-substituted derivatives such as alkyl peroxy benzoic acids, but also peroxy-α-naphtoic acid and magnesium monoperphthalate, (b) the aliphatic or substituted aliphatic peroxy acids, such as peroxy lauric acid, peroxy stearic acid, E-phthalimido peroxy caproic acid [phthalimino peroxy hexanoic acid (PAP)], o-carboxy benzamido peroxy caproic acid, N-nonenyl amido peradipic acid and N-nonenyl amido persuccinate, and (c) aliphatic and araliphatic peroxy dicarboxylic acids, such as 1,12-diperoxy carboxylic acid, 1,9-diperoxy azelaic acid, diperoxy sebacic acid, diperoxy brassylic acid, the diperoxy phthalic acids, 2-decyldiperoxybutane-1,4-di-acids, N,N-terephthaloyl-di(6-amino percaproic acid).

Substances that release chlorine or bromine can also be employed as bleaching agents. Examples of suitable materials that release chlorine or bromine are hetero-cyclic N-bromides and N-chloramides, for instance, trichloroisocyanuric acid, tribromoisocyanuric acid, dibromoisocyanuric acid and/or dichloroisocyanuric acid (DICA) and/or their salts with cations such as potassium and sodium. Hydantoin compounds, such as 1,3-dichloro-5,5-dimethyl hydanthoin are likewise suitable.

According to the invention, preference is given to washing or detergent compositions, especially dishwasher detergents, that contain 1% to 35% by weight, preferably 2.5% to 30% by weight, especially preferred 3.5% to 20% by weight, and especially 5% to 15% by weight, of bleaching agents, preferably sodium percarbonate.

The content of active oxygen in the washing or detergent compositions, especially in the dishwasher detergents, is preferably between 0.4% and 10% by weight, especially preferred between 0.5% and 8% by weight, and particularly between 0.6% and 5% by weight, relative to the total weight of the composition. Especially preferred compositions have a content of active oxygen above 0.3%, preferably above 0.7% by weight, especially preferred above 0.8%, and particularly above 1.0% by weight.

Bleach activators are used in washing or detergent compositions, for example, in order to attain a better bleaching effect at temperatures of 60° C. [140° F.] or less. Compounds that, under perhydrolysis conditions, yield aliphatic peroxocarboxylic acids having preferably 1 to 10 carbon atoms, especially 2 to 4 carbon atoms, and/or optionally substituted perbenzoic acid, can be employed as bleach activators. Suitable substances are those that carry O-acyl groups and/or N-acyl groups of the cited number of carbon atoms and/or optionally substituted benzoyl groups. Preference is given to the use of polyacylated alkylene diamines, especially tetra-acetyl ethylene diamine (TAED), acylated triazine derivatives, especially 1,5-di-acetyl-2,4-dioxohexahydro-1,3,5-triazine (DADHT), acylated glycoluriles, especially tetraacetyl glycolurile (TAGU), N-acylimides, particularly N-nonanoyl succinimide (NOSI), acylated phenol sulfonates, especially n-nonanoyl oxybenzene sulfonate or iso-nonanoyl oxybenzene sulfonate (n-NOBS or iso-NOBS), carboxylic acid anhydrides, especially phthalic acid anhydride, acylated polyvalent alcohols, especially triacetin, ethylene glycol diacetate and 2,5-diacetoxy-2,5-dihydrofuran, n-methyl-morpholinium-acetonitrile-methyl sulfate (MMA) as well as acetylated sorbitol and mannitol or their mixtures (SORMAN), acylated sugar derivatives, especially pentaacetyl glucose (PAG), pentaacetyl fructose, tetraacetyl xylose and octaacetyl lactose as well as acetylated, optionally N-alkylated glucamine and gluconolactone, and/or N-acylated lactams, for instance, N-benzoyl caprolactam. Hydrophilically substituted acylacetals and acyl lactams are likewise preferably used. Combinations of conventional bleach activators can also be used.

These bleach activators are preferably employed in amounts of up to 10% by weight, especially 0.1% to 8% by weight, particularly 2% to 8% by weight, and particularly preferred 2% to 6% by weight, each time relative to the total weight of the agents containing bleach activators.

Other bleach activators that are preferably employed within the scope of the present application are compounds from the group of the cationic nitrites, especially cationic nitrites having the formula

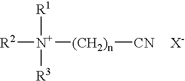

wherein R¹ stands for —H, —CH₃, for a C₂₋₂₄-alkyl radical or C₂₋₂₄-alkenyl radical, for a substituted C₂₋₂₄-alkyl radical or C₂₋₂₄-alkenyl radical having at least one substituent from the group —Cl, —Br, —OH, —NH₂, —CN, for an alkyl radical or alkenyl radical having a C₁₋₂₄-alkyl group, or for a substituted alkyl aryl radical or alkenyl aryl radical having a C₁₋₂₄-alkyl group and at least one additional substituent on the aromatic ring, R² and R³, independently of each other, are selected from among —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —C H(OH)—CH₂—CH₃, —(CH₂CH₂—O)ₙH, wherein n=1, 2, 3, 4, 5 or 6 and X is an anion.

Especially preferred is a cationic nitrile having the formula

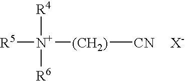

wherein R⁴, R⁵ and R⁶, independently of each other, are selected from among —CH₃, —CH₂—CH₃, —CH₂—CH₂—CH₃, —CH(CH₃)—CH₃, wherein R⁴ can additionally be —H and X is an anion, wherein preferably R⁵═R⁶═—CH₃ and especially R⁴═R⁵═R⁶═—CH₃ and compounds having the formulas (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X—, (CH₃CH(CH₃))₃N⁽⁺⁾CH₂—CN X⁻, or (HO—CH₂—CH₂)₃N⁽⁺⁾CH₂—CN X⁻ are especially preferred, whereby, among the group of these substances, special preference is given, in turn, to the cationic nitrile having the formula (CH₃)₃N⁽⁺⁾CH₂—CN X⁻, wherein X⁻ stands for an anion that is selected from the group consisting of chloride, bromide, iodide, hydrogen sulfate, methosulfate, p-toluene sulfonate (tosylate) or xylene sulfonate.

It is also possible to use so-called bleach catalysts in addition to the conventional bleach activators or instead of them. These bleach catalysts are bleach-enhancing transition metal salts or transition metal complexes such as, for instance, Mn—, Fe—, Co—, Ru— or Mo-salen complexes or Mn—, Fe—, Co—, Ru— or Mo-carbonyl complexes. Mn—, Fe—, Co—, Ru—, Mo—, Ti—, V— and Cu-complexes with tripod ligands containing nitrogen as well as Co—, Fe—, Cu— and Ru-ammine complexes can also be employed as bleach catalysts.

Bleach-enhancing transition metal complexes, especially having the central atoms Mn, Fe, Co, Cu, Mo, V, Ti and/or Ru, preferably selected from the group of the manganese and/or cobalt salts and/or complexes, especially preferred from the group of the cobalt (ammine) complexes, of the cobalt (acetate) complexes, of the cobalt (carbonyl) complexes, of the chlorides of cobalt or manganese, of manganese sulfate, are employed in the usual amounts, preferably in an amount of up to 5% by weight, especially from 0.0025% by weight to 1% by weight and especially preferred from 0.01% to 0.25% by weight, each time relative to the total weight of the compositions containing bleach activators. In special cases, however, more bleach activator can be employed.

Enzymes can be used for purposes of enhancing the washing or cleaning power of washing or detergent compositions. These include, in particular, proteases, amylases, lipases, hemicellulases, cellulases or oxidoreductases as well as, preferably, their mixtures. These enzymes are basically of natural origin; on the basis of the natural molecules, improved variants are available to be used in washing or detergent compositions and their use is correspondingly preferred. The washing or detergent compositions preferably contain enzymes in total amounts ranging from 1×10⁻⁶ to 5% by weight, relative to the active protein. The protein concentration can be ascertained by means of known methods, for instance, the BCA method or the Biuret method.

Among the proteases, preference is given to those of the subtilisin type. Examples of these are the subtilisins BPN′ and Carlsberg as well as their refined forms, the protease PB92, the subtilisins 147 and 309, the alkaline protease from Bacillus lentus, subtilisin DY and the enzymes thermitase, proteinase K and proteases TW3 and Tw7 which, strictly speaking, should be associated with the subtilases but no longer with the subtilisins.

Examples of the amylases that can be employed according to the invention are the α-amylases from Bacillus licheniformis, from B. amyloliquefaciens, from B. stearothermophilus, from Aspergillus niger and A. oryzae as well as refinements of the above-mentioned amylases, which have been improved for use in washing or detergent compositions. Moreover, special mention should be made of β-amylase from Bacillus sp. A7-7 (DSM 12368) and the cyclodextrin-glucanotransferase (CGTase) from B. agaradherens (DSM 9948) for this purpose.

According to the invention, it is likewise possible to use lipases or cutinases, especially in view of their triglyceride-splitting activities, but also for purposes of creating peracids in situ from suitable precursors. These include, for instance, the lipases that can be originally obtained from Humicola lanuginosa (Thermomyces lanuginosus) or else lipases that can be further refined, particularly those with the amino acid exchange D96L. Furthermore, it is also possible to employ, for example, the cutinases that were originally isolated from Fusarium solani pisi and Humicola insolens. It is likewise possible to use lipases, for example, cutinases whose initial enzymes were originally isolated from Pseudomonas mendocina and Fusarium solanii.

It is also possible to use enzymes that fall under the designation hemicellulases. These include, for example, mannanases, xanthan lyases, pectin lyases (=pectinases), pectin sterases, pectate lyases, xyloglucanases (=xylanases), pullulanases and β-glucanases.

In order to enhance the bleaching effect, oxidoreductases such as, for instance, oxidases, oxygenases, katalases, peroxidases such as halo-, chloro-, bromo-, lignin-, glucose or manganese-peroxidases, dioxygenases or laccases (phenol-oxidases, polyphenoloxidases) can be employed according to the invention. Advantageously, preferably organic, especially preferably aromatic compounds that interact with the enzymes are additionally added in order to enhance the activity of the oxidoreductases in question (enhancers) or for purposes of ensuring the flow of electrons between the oxidizing enzymes and the dirt in the case of highly divergent redox potentials (mediators).

The enzymes can be employed in any established form according to state of the art. These forms include, for instance, the solid preparations obtained through granulation, extrusion or lyophilization, or else, especially in the case of liquid or gel-like media, the solutions of the enzymes, which are advantageously as concentrated as possible, have a low content of water and/or are mixed with stabilizers.

As an alternative, the enzymes can be encapsulated for the solid as well as for the liquid application form, for instance, by means of spray drying or extrusion of the enzyme solution together with a preferably natural polymer or in the form of capsules, for example, those in which the enzymes are enclosed like in a solidified gel or in those of the core-shell type, in which a core containing the enzyme is coated with a protective layer that is impermeable to water, air and/or chemicals. Other active ingredients such as, for instance, stabilizers, emulsifiers, pigments, bleaching agents or dyes can be additionally applied in stacked layers. Such capsules are processed by means of familiar methods, for instance, by means of vibrating granulation or pelletization or else in fluid-bed processes. Advantageously, such granules are low-dust, thanks to the application of polymeric film formers, and they are storage-stable owing to the coating.

It is likewise possible to manufacture two or more enzymes together, so that one individual type of granules contains several enzyme activities.

A protein and/or enzyme can be protected, especially during storage, against damage such as, for example, inactivation, denaturation or decomposition caused, for instance, by physical influences, oxidation or photolytic cleavage. In the case of the microbial production of the proteins and/or enzymes, special preference is given to inhibiting the proteolysis, particularly if the compositions also contain proteases. For this purpose, the washing or detergent compositions can contain stabilizers; the provision of such compositions constitutes a preferred embodiment of the present invention.

In a preferred manner, one or more enzymes and/or enzyme preparations, preferably solid protease preparations and/or amylase preparations, are used in amounts ranging from 0.1% to 5% by weight, preferably 0.2% to 4.5% by weight and especially from 0.4% to 4% by weight, each time relative to the total composition containing enzymes.

Glass corrosion inhibitors prevent the occurrence of turbidity, striae and scratches as well as the irisation of the glass surface of glasses cleaned in dishwashers. Preferred glass corrosion inhibitors come from the group of magnesium and zinc salts as well as from the magnesium and zinc complexes.

The spectrum of the zinc salts preferred according to the invention, preferably organic acids, especially preferred organic carboxylic acids, ranges from salts that are hardly or not at all soluble in water, in other words, that have a solubility below 100 mg/l, preferably below 10 mg/l, especially below 0.01 mg/l, all the way to salts that exhibit a solubility in water above 100 mg/l, preferably above 500 mg/l, especially preferred above 1 g/l and particularly above 5 g/l (all solubility values at a water temperature of 20° C. [68° F.]). The first group of zinc salts includes, for example, zinc citrate, zinc oleate and zinc stearate, while the group of soluble zinc salts includes, for instance, zinc formiate, zinc acetate, zinc lactate and zinc gluconate.

Special preference as a glass corrosion inhibitor is given to at least one zinc salt of an organic carboxylic acid, especially preferred a zinc salt from the group consisting of zinc stearate, zinc oleate, zinc gluconate, zinc acetate, zinc lactate and zinc citrate. Likewise preferred are zinc ricinoleate, zinc abietate and zinc oxalate.

Within the scope of the present invention, the content of zinc salt in the washing or detergent compositions is preferably between 0.1% to 5% by weight, especially between 0.2% to 4% by weight and particularly between 0.4% and 3% by weight, or else the content of zinc in oxidized form (calculated as Zn²⁺) is between 0.01% and 1% by weight, preferably between 0.02% and 0.5% by weight, and especially between 0.04% and 0.2% by weight, each time related to the total weight of the composition containing glass corrosion inhibitors.

Corrosion inhibitors serve to protect the items being cleaned or the machine, whereby silver-protection agents have acquired particular significance in the realm of machine dishwashing. The substances known from the state of the art can be employed. Generally speaking, the silver-protection agents can be especially selected from the group consisting of triazoles, benzotriazoles, bisbenzotriazoles, aminotriazoles, alkyl aminotriazoles and transition metal salts or transition metal complexes. Special preference is given to the use of benzotriazole and/or alkyl aminotriazole. Preferred according to the invention are 3-amino-5-alkyl-1,2,4,-triazoles or their physiologically compatible salts, whereby these substances are preferably employed at a concentration ranging from 0.001% to 10% by weight, especially 0.0025% to 2% by weight, particularly preferred from 0.01% to 0.04% by weight. Examples of suitable acids for the salt formation are hydrochloric acid, sulfuric acid, phosphoric acid, carbonic acid, sulfurous acids, organic carboxylic acids such as acetic acid, glycolic acid, citric acid and succinic acid. Particularly effective are 5-pentyl-, 5-heptyl-, 5-nonyl-, 5-undecyl-, 5-isononyl-, 5-versatic-10-acid-alkyl-3-amino-1,2,4,-triazoles as well as mixtures of these substances.

Moreover, cleaning formulations often contain agents with active chlorine that can markedly reduce the corrosion of the silver surface. In chlorine-free cleaning products, especially organic redox-active compounds containing oxygen and nitrogen are employed, such as bivalent and trivalent phenols, for instance, hydroquinone, pyrocatechol, hydroxyhydroquinone, gallic acid, phloroglucin, pyrogallo or derivatives of these compound classes. Salt-like and complex-like inorganic compounds such as salts of the metals Mn, Ti, Zr, Hf, V, Co and Ce are also frequently employed. In this context, preference is given to the transition metal salts that are selected from the group consisting of manganese and/or cobalt salts and/or manganese and/or cobalt complexes, particularly preferred of cobalt (ammine) complexes, cobalt (acetate) complexes, cobalt (carbonyl) complexes, chlorides of cobalt or manganese and manganese sulfate. Zinc compounds can likewise be used to prevent the corrosion of the items being cleaned.

Instead of or in addition to the silver-protection agents described above, for instance, benzotriazoles, it is possible to employ redox-active substances. These substances are preferably inorganic redox-active substances from the group of manganese, titanium, zirconium, hafnium, vanadium, cobalt and cerium salts and/or complexes, whereby the metals are preferably present in one of the oxidation stages II, III, IV, V or VI.

The metal salts or metal complexes used should be at least partially soluble in water. The counter ions suitable for the salt formation encompass all of the familiar uninegatively, dinegatively or trinegatively charged inorganic anions, for instance, oxide, sulfate, nitrate, fluoride but also organic anions such as, for example, stearate.

Especially preferred metal salts and/or metal complexes are selected from the group consisting of MnSO₄, Mn(II)-citrate, Mn(II)-stearate, Mn(II)-acetyl acetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ as well as their mixtures, so that particular preference is given to the use of the metal salts and/or metal complexes selected from the group consisting of MnSO₄, Mn(II)-citrate, Mn(II)-stearate, Mn(II)-acetyl acetonate, Mn(II)-[1-hydroxyethane-1,1-diphosphonate], V₂O₅, V₂O₄, VO₂, TiOSO₄, K₂TiF₆, K₂ZrF₆, COSO₄, Co(NO₃)₂, Ce(NO₃)₃.

The inorganic redox-active substances, especially metal salts or metal complexes are preferably coated, that is to say, completely coated with a material that is water-proof but easily soluble at the washing temperatures, for purposes of preventing their premature decomposition or oxidation during storage. Preferred coating materials that are applied by means of known methods, for instance, the melt-coating method according to Sandwik as employed in the food industry are paraffins, microwaxes, waxes of natural origin such as carnauba wax, candellila wax, beeswax, higher-melting alcohols such as, for example, hexadecanol, soaps or fatty acids.

The cited metal salts and/or metal complexes are contained in the detergent compositions preferably in an amount ranging from 0.05% to 6% by weight, preferably from 0.2% to 2.5% by weight, each time relative to the total composition.

In order to facilitate the disintegration of the pre-fabricated shaped articles, it is possible to incorporate disintegration auxiliaries, so-called tablet disintegrants, into these compositions for purposes of shortening the disintegration times. The term tablet disintegrants or disintegration accelerators refers to auxiliaries that ensure a rapid disintegration of the tablets in water or other media as well as a quick release of the active ingredients.

These substances, which are referred to as disintegration agents because of their effect, increase their volume upon contact with water, whereby, on the one hand, the intrinsic volume is enlarged (swelling) and, on the other hand, pressure can be generated through the release of gases, said pressure causing the tablet to disintegrate into smaller particles. Well established disintegration auxiliaries are, for example, carbonate-citric acid systems, whereby other organic acids can also be employed. Swelling disintegration auxiliaries are, for instance, synthetic polymers such as polyvinyl pyrrolidone (PVP) or natural polymers or modified natural substances such as cellulose and starch and their derivatives, alginates or casein derivatives.

Preference is given to the use of disintegration auxiliaries in amounts ranging from 0.5% to 10% by weight, preferably from 3% to 7% by weight, and especially from 4% to 6% by weight, each time relative to the total weight of the agent containing disintegration auxiliaries.

The preferred disintegration agents used are disintegrants on the basis of cellulose, so that the preferred washing or detergent compositions contain such a cellulose-based disintegrant in amounts ranging from 0.5% to 10% by weight, preferably 3% to 7% by weight, and especially 4% to 6% by weight. Pure cellulose has the formal empirical composition (C₆H₁₀O₅)ₙ and, formally speaking, constitutes a β1,4-polyacetal of cellobiose which, in turn, is made up of two molecules of glucose. In this context, suitable celluloses consist of approximately 500 to 5000 glucose units and consequently have average molar masses ranging from 50,000 to 500,000. Within the scope of the present invention, it is likewise possible to use, as cellulose-based disintegrants, cellulose derivatives that can be obtained from cellulose by means of polymer-analogous reactions. Such chemically modified celluloses encompass, for example, products from esterifications or etherifications in which hydroxy-hydrogen atoms have been substituted. However, celluloses in which the hydroxy groups have been replaced by functional groups that are not bound via an oxygen atom can also be used as cellulose derivatives. This group of cellulose derivatives includes, for example, alkali celluloses, carboxymethyl cellulose (CMC), cellulose ester and cellulose other as well as aminocelluloses. The cited cellulose derivatives are preferably employed not alone as the disintegrant but rather in a mixture with cellulose.

The content of these mixtures of cellulose derivatives preferably lies below 50% by weight, especially preferred below 20% by weight, relative to the cellulose-based disintegrant. As the cellulose-based disintegrant, particular preference is given to the use of pure cellulose that is free of cellulose derivatives.

The cellulose employed as the disintegration auxiliary is preferably not used in a fine-particle form but rather, converted—e.g. granulated or compacted—into a coarser form prior to being added to the premixes that are to be compressed. The particle size of such disintegrants is usually above 200 μm, preferably at least 90% by weight of the particles are between 300 μm and 1600 μm, and especially at least 90% by weight of the particles are between 400 μm and 1200 μm.

Microcrystalline cellulose can be used as another cellulose-based disintegrant or as part of this component. This microcrystalline cellulose is obtained through the partial hydrolysis of celluloses under conditions that are such that only the amorphous areas (approximately 30% of the total cellulose mass) of the celluloses are attacked and completely dissolved while the crystalline areas (approximately 70%) remain unaffected. The subsequent disaggregation of the microfine celluloses formed by the hydrolysis then yields the microcrystalline celluloses that exhibit primary particle sizes of about 5 μm and that can be compacted to form, for example, granules having a mean particle size of 200 μm.

Preferred disintegrants, preferably a cellulose-based disintegration auxiliary, preferably in granular, co-granular or compacted form, are contained in the compositions containing disintegrants in amounts ranging from 0.5% to 10% by weight, preferably from 3% to 7% by weight, and especially from 4% to 6% by weight, each time relative to the total weight of the composition containing disintegrants.

According to the invention, preference is also given to the use of gas-forming effervescent systems as tablet-disintegration auxiliaries. The gas-forming effervescent system can consist of a single substance that releases a gas upon contact with water. Among these compounds, special mention should be made of magnesium peroxide, which releases oxygen upon contact with water. Normally, however, the gas-releasing effervescent system, in turn, consists of at least two ingredients that react with each other to form a gas. While many systems that release, for instance, nitrogen, oxygen or hydrogen, are conceivable and feasible in this context, the effervescent system used in the washing or detergent composition can be selected on the basis of economic as well as environmental considerations. Preferred effervescent systems consist of alkali metal carbonate and/or alkali hydrogen carbonate as well as an acidification agent that is suitable to release carbon dioxide from the alkali metal salts in an aqueous solution.

Examples of acidification agents that can be used to release carbon dioxide from the alkali metal salts in an aqueous solution are boric acid as well as alkali metal hydrogen sulfates, alkali metal hydrogen phosphates and other inorganic salts. However, preference is given to the use of organic acidification agents, whereby citric acid is a particularly preferred acidification agent. In the effervescent system, preference is given to acidification agents from the group of organic dicarboxylic acids, tricarboxylic acids and oligocarboxylic acids or mixtures thereof.

Individual aroma compounds, for example, synthetic products of the type of esters, ethers, aldehydes, ketones, alcohols and hydrocarbons can be employed as perfume oils or scents within the scope of the present invention. However, preference is given to the use of mixtures of various aroma substances that together create a pleasant fragrance. Such perfume oils can also contain natural aroma mixtures of the type available from plant-based sources, for instance, pine oil, lemon oil, jasmine oil, patchouli oil, rose oil or ylang-ylang oil.

In order to be perceptible, an aroma substance has to be volatile, whereby not only the nature of the functional groups and the structure of the chemical compound but also the molar mass play an important role. For instance, most aroma substances have atomic masses of up to about 200 dalton, whereas atomic masses of 300 dalton and more constitute an exception. Owing to the different volatility of scent substances, the smell of a perfume or scent made up of several aroma substances changes during evaporation, whereby the smell perceptions are broken down into “top note”, “middle note” or “body” and “end note” or “dry out”. Since the perception of smell is also largely based on the intensity of the smell, the top note of a perfume or scent does not consist only of highly volatile compounds, whereas the end note consists largely of less volatile, that is to say, lingering aroma substances. In the composition of perfumes, highly volatile aroma substances can be, for example, bound to certain fixatives, as a result of which their fast evaporation is prevented. Therefore, the following division of the aroma substances into “more volatile” or “lingering” aroma substances does not provide any information about the smell impression or whether the corresponding aroma substance is perceived as a top note or a middle note.

The aroma substances can be processed directly, although it can also be advantageous to apply the aroma substances onto carriers that ensure a lasting fragrance by providing a slower release of the fragrance. Cyclodextrins, for example, have proven their worth as such carrier materials, whereby the cyclodextrin-perfume complexes can still be additionally coated with other auxiliaries.

Preferred dyes, whose selection does not pose a problem for the person skilled in the art, have a good storage stability and are impervious to the other ingredients in the composition and to light, and they do not display any pronounced substantivity vis-à-vis the substrates that are to be treated with the compositions containing dyes, such as, for instance, textiles, glass, ceramic or plastic dishware, so that these items do not become stained.

When the dye is chosen, care should be taken to ensure that the dye has good storage stability and is impervious to light. At the same time, when suitable dyes are being selected, it is necessary to take into consideration that dyes exhibit different levels of stability against oxidation. It can be generally said that water-insoluble dyes are more stable against oxidation than water-soluble dyes. Depending on the solubility and thus on the oxidation sensitivity, the concentration of the dye in the washing or detergent compositions varies. In the case of readily water-soluble dyes, their concentration is typically selected within the range of several 10⁻²% to 10⁻³% by weight. When it comes to pigment dyes, which are preferred because of their brilliance but which are not as readily water-soluble, the suitable concentration of the dye in the washing or detergent compositions, in contrast, is typically several 10⁻³% to 10⁻⁴% by weight.

Preference is given to dyes that can be oxidatively destroyed during the washing process as well as to mixtures thereof with suitable blue dyes, so-called blue toners. It has proven to be advantageous to employ dyes that are soluble in water or in liquid organic substances that are soluble at room temperature. Suitable dyes in this context are, for example, anionic dyes such as anionic nitroso dyes.

Aside from the components that have been comprehensively described above, the washing or detergent compositions can also contain other ingredients that further improve the application and/or esthetic properties of these compositions. Preferred compositions comprise one or more substances from the group of electrolytes, pH adjusters, fluorescent agents, hydrotopes, foam inhibitors, silicone oils, anti-redeposition agents, brighteners, graying inhibitors, anti-shrinking agents, anti-wrinkle agents, bleeding inhibitors, antimicrobial active ingredients, germicides, fungicides, antioxidants, antistatic agents, ironing auxiliaries, phobing and impregnating agents, anti-swelling agents and anti-slip agents as well as UV absorbers.

A wide array of salts can be employed as electrolytes from the group of inorganic salts. Preferred cations are alkali and earth-alkali metals while preferred anions are halides and sulfates. From the standpoint of production technology, preference is given to the use of NaCl or MgCl₂ in the washing or detergent compositions.

In order to set the pH value of the washing or detergent compositions within the desired range, it can be recommended to employ pH adjusters. All of the known acids or alkaline solutions can be employed in this context, provided that their use is not prohibited due to technical or environmental considerations or because of consumer protection legislation. Normally, the amount of these adjusters does not exceed 1% by weight of the total formulation.

Soaps, oils, fats, paraffins or silicon oils, among others, can be employed as foam inhibitors and can optionally be applied onto carrier materials. Examples of suitable carrier materials are inorganic salts such as carbonates or sulfates, cellulose derivatives or silicates as well as mixtures of the above-mentioned materials. Compositions preferred within the scope of the present application contain paraffins, preferably unbranched paraffins (n-paraffins) and/or silicones, preferably linear-polymeric silicones that are structured according to the formula (R₂SiO)ₓ and that are also referred to as silicone oils. These silicone oils are normally clear, colorless, neutral, odor-free, hydrophobic liquids having a molecular mass between 1000 and 150,000 as well as viscosity values between 10 and 1,000,000 mPa·s.

Suitable anti-redeposition agents, which are also referred to as dirt repellents, are, for instance, non-ionic cellulose ethers such as methyl cellulose and methyl hydroxy propyl cellulose containing 15% to 30% by weight of methoxy groups and 1% to 15% by weight of hydroxy propyl groups, each time relative to the non-ionic cellulose ethers, as well as the polymers of phthalic acid and/or terephthalic acid or their derivatives known from the state of the art, particularly polymers from ethylene terephthalates and/or polyethylene glycol terephthalates or anionically and/or non-ionically modified derivatives thereof. Especially preferred among these are the sulfonated derivatives of phthalic acid and terephthalic acid polymers.

Brighteners (so-called “whitening agents”) can be added to the washing or detergent compositions for purposes of eliminating graying or yellowing of the treated textiles. These substances attach to the fibers and bring about a brightening and simulated bleaching effect in that they convert invisible ultraviolet light into visible longer-wave light, whereby the ultraviolet light absorbed from sunlight is emitted as a slightly bluish fluorescence and, together with the yellow tone of the grayed or yellowed laundry, yields pure white. Suitable compounds come, for example, from the substance classes consisting of 4,4′-diamino-2,2′-stilbene-disulfonic acids (flavonic acids), 4-4′-distyryl-biphenylene, methyl umbelliferones, coumarins, dihydro-quinolinones, 1,3-diarylpyrazolines, naphthalic acid imides, benzoxazole systems, benzisoxazole systems and benzimidazole systems as well as pyrene derivatives substituted with hetereocyclene.

Graying inhibitors have the task to keep the dirt that was lifted from the fibers suspended in the liquor so as to prevent the dirt from being re-deposited. Suitable substances for this purpose are water-soluble colloids, usually of an organic nature, for instance, the water-soluble salts of polymeric carboxylic acids, glues, gelatins, salts of ether sulfonic acids of starch or of cellulose, or else salts of acidic sulfuric acid esters of cellulose or of starch. Water-soluble polyamides containing acidic groups are also suitable for this purpose. Soluble starch preparations and starch products other than the above-mentioned ones can also be employed, for example, degraded starch, aldehyde starches, etc. It is likewise possible to use polyvinyl pyrrolidone. Cellulose ethers such as carboxy methyl cellulose (Na salt), methyl cellulose, hydroxy alkyl cellulose and heteroethers such as methyl hydroxy ethyl cellulose, methyl hydroxy propyl cellulose, methyl carboxy-methyl cellulose and their mixtures can likewise be employed as graying inhibitors.

Since textile fabrics, especially those made of rayon, viscose, cotton and their blends can have a tendency to wrinkle because the individual fibers are sensitive to bending, kinking, pressing and squeezing crosswise to the fiber direction, synthetic anti-wrinkle agents can be employed. These include, for instance, synthetic products on the basis of fatty acids, fatty acid esters, fatty acid amides, fatty acid alkylol esters, fatty acid alkylol amides or fatty alcohols, which are usually reacted with ethylene oxide, or else products on the basis of lecithin or modified phosphoric acid esters.

Phobing and impregnating methods serve to provide textiles with finishes containing substances that prevent the deposition of dirt or which make it easier to wash the dirt out. Preferred phobing and impregnating agents are perfluorinated fatty acids, also in the form of their aluminum and zirconium salts, organic silicates, silicones, polyacrylic acid esters with a perfluorinated alcohol component or with polymerizable compounds coupled with a perfluorinated acyl or sulfonyl radical. The products can also contain anti-static agents. The dirt-repellent finishing with phobing and impregnating agents is often classified as an easy-care finish. The penetration of the impregnating agent in the form of solutions or emulsions of the active ingredients in question can also be facilitated by adding wetting agents that lower the surface tension. Another area of application for phobing and impregnating agents is the water-repellent finishing of textiles, tents, tarpaulins, leather, etc., whose fabric pores are not sealed—unlike with water-proofing—in other words, the material remains breathable (hydrophobing). The hydrophobing agents used for the hydrophobization pressure serve to coat textiles, leather, paper, wood, etc. with a very thin layer of hydrophobic groups such as longer alkyl chains or siloxane groups. Suitable hydrophobing agents are, for example, paraffins, waxes, metal soaps, etc. with admixtures of aluminum or zirconium salts, quaternary ammonium compounds having long-chain alkyl radicals, urea derivatives, fatty acid-modified melamin resins, chromium complex salts, silicones, tin-organic compounds and glutaric dialdehyde as well as perfluorinated compounds. The hydrophobized materials do not feel greasy and yet drops of water are repelled by them—like with oiled materials—without wetting them. In this manner, for instance, silicone-impregnated textiles have a soft hand and are water-repellent and dirt-repellent; stains caused by ink, wine, fruit juice and the like can be removed more easily.

Antimicrobial active ingredients can be employed in order to combat micro-organisms. In this context, a distinction is made between bacteriostatic agents and bactericides, fungistatic agents and fungicides, etch, depending on the antimicrobial spectrum and mechanism of action. Important substances from this group are, for example, benzalkonium chlorides, alkyl aryl sulfonates, halogen phenols and phenol mercuriacetate, whereby it also possible to completely dispense with these compounds.

In order to avoid undesired changes in the washing or detergent compositions and/or in the treated textiles caused by the effect of oxygen or by other oxidative processes, the compositions can contain antioxidants. This class of compounds includes, for instance, substituted phenols, hydroquinones, pyrocatchechols and aromatic amines as well as organic sulfides, polysulfides, dithiocarbamates, phosphites and phosphonates.

Greater wearing comfort can be obtained through the additional use of antistatic agents. The latter increase the surface conductivity, thus allowing a better dissipation of charges that are build up. As a rule, external antistatic agents are substances having at least one hydrophilic molecule ligand and they impart the surface with a more or less hygroscopic film. These usually surface-active antistatic agents can be broken down into antistatic agents containing nitrogen (amines, amides, quaternary ammonium compounds), antistatic agents containing phosphorus (phosphoric acid esters) and antistatic agents containing sulfur (alkyl sulfonates, alkyl sulfates). Lauryl dimethyl benzyl ammonium chlorides (or stearyl dimethyl benzyl ammonium chlorides) are likewise suitable as antistatic agents for textiles or as additives to detergents, whereby a softening effect is additionally achieved.

Silicone derivatives can be employed for purposes of improving the water-absorption capacity and the re-wettability of the treated textiles as well as for facilitating the ironing of the treated textiles. Thanks to their foam-inhibiting properties, these silicone derivatives also improve the rinsing behavior of the washing or detergent compositions. Preferred silicone derivatives are, for example, polydialkyl siloxanes or alkyl aryl siloxanes in which the alkyl groups have one to five carbon atoms and are partially or totally fluorinated. Preferred silicones are polydimethyl siloxanes which can optionally be derivatized and are then aminofunctional or quaternated, or have Si—OH, Si—H and/or of Si—Cl bonds. Other preferred silicones are the polyalkylene oxide-modified polysiloxanes, in other words, polysiloxanes that have, for instance, polyethylene glycols, as well as the polyalkylene oxide-modified dimethyl polysiloxanes.

Finally, according to the invention, it is also possible to employ UV absorbers that are attached to the treated textiles and improve the light resistance of the fibers. Compounds that have these desired properties are, for example, the compounds that are effective due to radiation-free de-activation as well as derivatives of benzophenone with substituents in the 2-position and/or in the 4-position. Likewise suitable are substituted benzotriazoles, acrylates that are phenyl-substituted in the 3-position (cinnamic acid derivatives), optionally with cyano groups in the 2-position, salicylates, organic nitrogen complexes as well as natural substances such as umbelliferone and the body's own urocanic acid.

Within the scope of the present invention, protein hydrolysates, owing to their fiber-care effect, are additionally preferred active substances in the realm of washing or detergent compositions. Protein hydrolysates are product mixtures that are obtained through the acidically, alkalinically or enzymatically catalyzed degradation of proteins. According to the invention, protein hydrolysates of plant-based or animal-based origin can be employed. Examples of protein hydrolysates of animal origin are elastin-, collagen-, keratin-, silk- and milkprotein hydrolysates, which can also be present in the form of salts. According to the invention, preference is given to the use of protein hydrolysates of plant origin, for example, soy-, almond-, rice-, pea-, potato- and wheat-protein hydrolysates. Even though the use of protein hydrolysates as such is preferred, amino acid mixtures or individual amino acids obtained in a different manner can be used in their place, examples of which are arginine, lysin, histidine or pyroglutamic acid. It is likewise possible to use derivatives of the protein hydrolysates, for example, in the form of their fatty acid condensation products.

1. (canceled)

2. (canceled)

3. (canceled)

4. (canceled)

5. (canceled)

6. (canceled)

7. (canceled)

8. (canceled)

9. (canceled)

10. A method for the production of a washing or detergent composition unit dose comprising the steps:
a) providing a washing or detergent composition in the form of a ring-shaped tablet having a cavity with at least two opening surfaces;
b) closing one of the opening surfaces with a pre-fabricated, filled and closed water-soluble packet;
c) filling the cavity with a washing-active or detergent-active composition.

11. The method of claim 10, wherein the ring-shaped tablet and the water-soluble packet are joined by an adhesive.

12. The method of claim 11, wherein the ring-shaped tablet and the water-soluble packet are joined by exposure to a heated sealing tool.

13. The method of claim 10, wherein the ring-shaped tablet and the water-soluble packet are joined by a latching connection, a snap-on connection, or a plug-in connection.

14. The method of claim 10, wherein the water-soluble packet is a thermoformed packet or an injection-molded packet.

15. The method of claim 10, wherein the water-soluble packet is filled with a flowable washing-active or detergent-active composition.

16. The method of claim 15, wherein the flowable washing-active or detergent-active composition is a gel.

17. The method of claim 10, wherein the cavity is filled with a flowable washing-active or detergent-active composition.

18. The method of claim 10, wherein the cavity is filled with a solid washing-active or detergent-active composition.

19. The method of claim 10, further comprising step d), wherein the remaining opening surfaces of the cavity are sealed.

20. The method of claim 10, further comprising step d), wherein the remaining opening surfaces of the cavity are sealed with a water-soluble film or a pre-fabricated, filled and closed water-soluble packet, and wherein the water-soluble film or the water-soluble packet are joined to the ring-shaped tablet by an adhesive.

21. The method of claim 20, wherein the ring-shaped tablet and the water-soluble packet are joined by exposure to a heated sealing tool.
